(19) United States
(12) Patent Application Publication
(10) Pub. No.: US 2026/0210900 A1
(43) Pub. Date: Jul. 23, 2026

(54) PULSED CURRENT ANION SELECTIVE ELECTRODES

(71) Applicant: The Curators of the University of Missouri, Columbia, MO (US)

(72) Inventors: Matthias J. Young, Columbia, MO (US); Ryan Gettler, Columbia, MO (US); Shima Mehregan, Columbia, MO (US); Henry Koenig, Columbia, MO (US)

(21) Appl. No.: 19/346,764

(22) Filed: Oct. 1, 2025

Related U.S. Application Data
(60) Provisional application No. 63/701,686, filed on Oct. 1, 2024.

(51) Int. Cl. G01N 27/333

(52) U.S. Cl. CPC G01N 27/3335

(57) ABSTRACT

Described herein in various embodiments is an ion-selective electrode (ISE) for anion detection comprises a working electrode, a redox-active conducting polymer transduction layer, and an ion-selective membrane (ISM) with thickness less than 100 μm. The ISM can be formed without ionophores, ion templating, or dopants. A method for selectively measuring anion concentration described herein involves exposing the ISE to a liquid sample to form a sample-ISM interface, allowing equilibration to establish an equilibrium phase boundary potential, applying an electrical current pulse to reversibly oxidize the transduction layer while measuring the charged phase boundary potential, calculating the phase boundary potential change (Δφ) by subtracting equilibrium from charged potentials, and determining anion concentration from the phase boundary potential change.

### CROSS-REFERENCE TO RELATED APPLICATIONS

This application claims priority to U.S. Provisional Application No. 63/701,686 filed on Oct. 1, 2024, the content of which (text, drawings, and claims) is incorporated herein by reference.

### GOVERNMENT RIGHTS

This invention was made with government support under G21AC10446 awarded by the U.S. Geological Survey. The government has certain rights in the invention.

### TECHNICAL FIELD

The present teachings relate to ion selective electrodes, and more particularly low-cost portable nitrate and phosphate sensors.

### BACKGROUND

Excess bioavailable nutrients, such as nitrates and phosphates, in large bodies of water pose serious ecological and human health concerns, including freshwater eutrophication and methemoglobinemia. Agricultural runoff represents a primary source of these pollutants, leaching soluble ions into aquatic ecosystems and drinking water supplies. Real-time monitoring of local ion concentrations is essential for regulatory action and environmental protection. Ion-selective electrodes (ISEs) have emerged as attractive analytical tools for measuring aqueous ion activities due to their ease of use, commercial accessibility, and high throughput capability compared to laboratory techniques like ion chromatography.

Solid contact ion-selective electrodes (SC-ISEs) show particular promise for nutrient sensing applications, having been successfully demonstrated in soils, drinking water, and agricultural wastewater. These devices typically employ ion-selective membrane (ISM) layers containing organic ionophores that selectively bind target ions, providing the necessary selectivity for accurate measurements. Known ISEs typically rely on equilibrium measurement techniques, where ion concentrations are measured using ISEs held at open circuit potential.

However, anion detection remains challenging and faces fundamental limitations that restrict their widespread deployment. Anion-selective ionophores are scarce, expensive, and exhibit variable performance. Conventional ISEs require thick membranes (200-500 μm) to achieve Nernstian responses and prevent spontaneous membrane discharge, resulting in excessive material consumption and slow equilibration times. While thinner membranes would reduce costs, they fail to provide reliable responses in conventional measurements. Although non-equilibrium techniques have shown promise for improving sensor performance with thinner membranes, their application has been largely limited to cation sensors. Additionally, the governing physics and design principles for optimizing these active measurement approaches remain poorly understood, severely hampering further development.

There is thus a need in the art for novel ISMs that employ low-cost thin membrane layers and function for anion detection.

### BRIEF SUMMARY

Described herein is an ion-selective electrode (ISE) that consists of three main components: a working electrode, a transduction layer disposed on the working electrode, and an ion-selective membrane (ISM) disposed on the transduction layer. The ISM has a thickness of less than 100 μm, and in some embodiments, this thickness can be less than 100 nm.

The transduction layer is typically made of a redox-active conducting polymer. In various exemplary embodiments, materials used for this layer can include polypyrrole, polyaniline, poly(3,4-ethylenedioxythiophene) (PEDOT), polythiophene, poly(3-hexylthiophene), polyindole, polycarbazole, polyfuran, poly(phenylenevinylene), poly(p-phenylene), polyacetylene, or similar conducting polymers.

The ion-selective membrane can be formed through a process of molecular-layer deposition. Notably, the ion-selective membrane is exclusive of ionophores and can be formed by a process that excludes ion templating. The membrane is also exclusive of dopants. In various exemplary embodiments, the ISM comprises a homopolymer or copolymer of various materials, including polypyrrole, polyaniline, poly(3,4-ethylenedioxythiophene), polythiophene, poly(p-phenylenediamine), polythiourea, polyethyleneimine, poly(allylamine), ethyl cellulose, poly(methyl methacrylate), poly(vinylidene fluoride-co-hexafluoropropylene) (PVDF-HFP), poly(vinyl alcohol), poly(2-hydroxyethyl methacrylate), polyacrylamide, perfluorosulfonic acid ionomer, sulfonated polystyrene (PSS) ionomer, and PTFE.

Also described is a method for selectively measuring the concentration of an anion in a liquid sample using the ISE. The method begins with a sample exposure step, where the ion-selective electrode is exposed to the liquid sample, forming a sample-ISM interface between the liquid sample and the ISM. This is followed by an equilibration step, during which an equilibrium phase boundary potential forms at the sample-ISM interface and is measured and recorded.

Next comes a charging step, where an electrical current pulse is applied to reversibly oxidize the transduction layer. During this step, the charged phase boundary potential at the sample-ISM interface is measured and recorded. The method then includes a phase boundary change calculation step, which involves subtracting the equilibrium phase boundary potential from the charged phase boundary potential to calculate a phase boundary potential change Δφ. Finally, a concentration calculation step determines the concentration of the anion in the liquid sample from the phase boundary potential change Δφ. The method can also include a regeneration step after the charging step.

The system for selectively measuring anion concentration comprises the ion-selective electrode described above, along with an analytical instrument operably connected to the ion-selective electrode, a reference electrode operably connected to the analytical instrument, and a counter electrode also operably connected to the analytical instrument. The reference electrode may be a polarizable reference electrode. The system can include at least one additional ion-selective electrode when the liquid solution contains a plurality of different anion species. In such exemplary embodiments, each of the ISE and the at least one additional ISE are connected to the same analytical instrument (such as potentiostat). The cumulative signal acquired by the ISE and all of the at least one additional ISEs are then analyzed and disambiguated by a machine learning system that has been trained on liquid samples with the plurality of anion species. In this way, the concentrations of multiple different anion species can be measured by a single system comprising an ISE and at least one additional ISE.

### BRIEF DESCRIPTION OF THE FIGURES

FIG. 1A exemplarily depicts a schematic of a pulsed current ion selective electrode (ISE) in accordance with various embodiments of the present disclosure.

FIG. 1B exemplarily depicts a flowchart for a method of operating the pulsed current ISE in accordance with various embodiments of the present disclosure.

FIG. 2A exemplarily depicts zero-current potentiometry in a traditional ISE, where free energy (ΔG) dictates response, and FIG. 2B exemplarily depicts applied current conditions in an ion conducting film, where overpotential (φ) influences the analytical signal in accordance with various embodiments of the present disclosure.

FIG. 2B exemplarily depicts electrode cross-section showing changes at phase boundaries 1-3, and reaction diagrams for migration of target A and interferent X under zero-current potentiometry in a traditional ISE, where free energy (ΔG) dictates response, in accordance with various embodiments of the present disclosure.

FIG. 2C exemplarily depicts electrode cross-section showing changes at phase boundaries 1-3, and reaction diagrams for migration of target A and interferent X in accordance with various embodiments of the present disclosure.

FIG. 2D exemplarily depicts electrode cross-section showing an ion conducting membrane with increased flux for the target anion A⁻ over interfering anions X⁻ during galvanostatic polarization in accordance with various embodiments of the present disclosure.

FIG. 3A exemplarily depicts electrical potential as a function of time during galvanostatic charging in accordance with various embodiments of the present disclosure.

FIG. 3B exemplarily depicts a schematic of the absorption of an analyte anion and transfer of electronic current into a working electrode during galvanostatic charging in accordance with various embodiments of the present disclosure.

FIG. 3C exemplarily depicts electrical current as a function of time during a stripping set subsequent to galvanostatic charging in accordance with various embodiments of the present disclosure.

FIG. 3D exemplarily depicts a schematic of the discharging of an analyte anion and transfer of electronic current out of a working electrode during a stripping set subsequent to galvanostatic charging in accordance with various embodiments of the present disclosure.

FIG. 4A exemplarily depicts a comparison of experimental (black) and predicted (red) nitrate response curves at an applied current of 2 μA for 1 s with a 0.01 M Na₂SO₄ ionic strength adjuster in accordance with various embodiments of the present disclosure. Error bars are representative of two repeat measurements at each concentration. Sensitivity S (mV/log a) is given by the slope of the experimental curve. Model parameters are as follows: D=10⁻⁵ cm²/s, D̅=10⁻⁷ cm²/s, R_{T}3 μmol/cm³, L_{T}=30 μmol/cm³, β_{NO3}=1.4, k_{NO3}=0.00015, k_{CP}=15, ΔV=20 mV, A=0.17 cm², a_{CP}=6 mmol/cm³, and T=300 K.

FIG. 4B exemplarily depicts variation in potential over time for an ISE in open-circuit conditions in accordance with various embodiments of the present disclosure. Approximate activities corresponding to the potential step are indicated at each step. Sensitivity S is shown for each condition.

FIG. 4C exemplarily depicts variation in potential over time for an ISE at 2 μA applied current in accordance with various embodiments of the present disclosure. Approximate activities corresponding to the potential step are indicated at each step. Sensitivity S is shown for each condition.

FIG. 5 exemplarily depicts comparisons of nitrate calibration curves using a SSC and graphite reference electrode in accordance with various embodiments of the present disclosure. Calibration is calculated at 2 μA input signal and 1 s pulse width in 0.01 M Na₂SO₄ background electrolyte. Error bars are representative of two repeat measurements each.

FIG. 6 exemplarily depicts polarization curves obtained in separate 0.01 M solutions of NaNO₃ and NaCl as well as the resulting selectivity factors as a function of current are also shown in accordance with various embodiments of the present disclosure.

FIG. 7A exemplarily shows theoretical response curves using nitrate-templated molecularly imprinted polymer (MIP-N) sensors at 3 uA current with a 1 s pulse width in a 0.1 M Na₂SO₄ ionic strength adjustor, where the model mobilities are reported relative to the max value necessary to reproduce the experimental curves in FIG. 7B, in accordance with various embodiments of the present disclosure.

FIG. 7B exemplarily shows experimental response curves using nitrate-templated molecularly imprinted polymer (MIP-N) sensors at 3 uA current with a 1 s pulse width in a 0.1 M Na₂SO₄ ionic strength adjustor in accordance with various embodiments of the present disclosure.

FIG. 7C exemplarily shows a comparison between nitrate response under open-circuit and applied current conditions in accordance with various embodiments of the present disclosure.

FIG. 7D exemplarily shows selectivity factors showing preference of MIP-N sensors over chloride, phosphate and perchlorate in accordance with various embodiments of the present disclosure. The selectivity factor K_{NO3,H2PO4} was calculated assuming all phosphate ions are in the −1 charge state. Error bars are representative of sample standard deviations for three electrodes with two measurements each.

FIG. 8A exemplarily shows response curves of phosphate templated molecularly imprinted polymers (MIP-P) to monobasic and dibasic phosphate as well as other interferents using 3 μA applied current with a 1 s pulse width in 0.1 M Na2SO4 ionic strength adjustor in accordance with various embodiments of the present disclosure.

FIG. 8B exemplarily shows selectivity factors estimated from the panel depicted pin FIG. 8A in accordance with various embodiments of the present disclosure. Error bars are representative of samples standard deviations from two electrodes with two measurements each.

FIG. 9 exemplarily shows pulsed current results over the range of the current but for 0.001 M concentration for each anion in solution for a single electrode in accordance with various embodiments of the present disclosure.

FIG. 10 exemplarily shows featurization of data simulated as described below in Example 2 in accordance with various embodiments of the present disclosure.

FIG. 11A exemplarily shows a comparison of absolute percent error for various machine learning models as described below in Example 2 in accordance with various embodiments of the present disclosure.

FIG. 11B exemplarily shows a comparison of the performance of various machine learning models of the type described in Example 2 below tested on decision tree, polynomial kernel ridge regression, multilayer perceptron, and random forest in accordance with various embodiments of the present disclosure.

FIG. 12A exemplarily shows the mean absolute percent error as a function of number of features from machine learning models as described in Example 2 below in accordance with various embodiments of the present disclosure.

FIG. 12B exemplarily illustrates the mean absolute percent error calculated for various dataset sizes ranging from 100 to 105 simulated experiments in accordance with various embodiments of the present disclosure.

FIG. 13 exemplarily illustrates the effect of current on potential shifts under pulse current measurements for nitrate at 0.01 M and various pulsed current values as shown, in accordance with various embodiments of the present disclosure.

FIG. 14A exemplarily shows response curves using polythioruea sensors pulsed at 100 μA current in three different concentrations (0.01, 0.1, and 1 M) nitrate, chloride, carbonate, perchlorate, sulfate, and phosphate in accordance with various embodiments of the present disclosure.

FIG. 14B exemplarily shows calculated selectivity response factors for chloride, carbonate, sulfate, phosphate, and perchlorate anions in accordance with various embodiments of the present disclosure.

FIG. 15A exemplarily shows a response curve of sensors to nitrate and chloride for sensors in which polythiourea was deposited at 140° C. in accordance with various embodiments of the present disclosure.

FIG. 15B exemplarily shows selectivity factors estimated from the sensor panel described in Example 3 below and with respect to FIG. 15A in accordance with various embodiments of the present disclosure.

FIG. 16 exemplarily shows Raman spectroscopy of polythioruea films deposited at various temperatures as described in Example 3 below in accordance with various embodiments of the present disclosure.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what is believed to be the best mode of carrying out the claimed invention. Additionally, it is to be understood that the claimed invention is not limited in its applications to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

The term “polymer” as used herein is considered to be inclusive of polymers made from a single repeating monomeric subunit as well as what are commonly called “copolymers,” or polymers made from more than one monomeric subunit. The term “copolymer” is used herein specifically to denote polymers made from more than one type of repeating monomeric subunit. The term “hydrogel” is a kind of polymer that can absorb and retain large amounts of water relative to most polymers.

The term “support material” as used herein refers to an inert substrate (often a polymer film, mesh, or porous layer) that provides mechanical stability and handling strength to a polymer such as an ion-selective membrane. A support material doesn't actively participate in ion recognition or transport.

The terms “noise” and “noisy” as used herein refer to undesirable random or stochastic fluctuations in a measurement that obscure an accurate reading of the parameter of interest. For example, a ‘noisy’ measurement of electric potential is one in which the accurate electric potential value is obscured by irreducible variability in the measurement of the electric potential. Although mathematical treatments for the suppression of noise are well known, the physical origins of noise can be diverse, and thus measurement techniques that are inherently less noisy can be desirable.

The following description includes references to the measurement and application of electrical potential as well as the measurement and application of electrical current. Unless stated otherwise, electrical potential and current are applied and/or measured between a working electrode and a reference electrode. However, the electrical potential measured between a given working electrode and reference electrode includes all of the electrical potential changes across any materials and interfaces that exist between the given working electrode and reference electrode. For example, a measurement of a phase boundary potential across a surface of a membrane that has been disposed atop a working electrode is, unless stated otherwise, performed by measuring the electrical potential between the working electrode and reference electrode, as that measurement contains within itself the measurement of the phase boundary potential across the surface of the membrane.

As described herein, the present disclosure provides galvanostatic ion-selective electrodes (ISEs) that can be used to calculate anion concentrations in a solution. The ISEs described herein solve many of the problems inherent to previously-known ISEs by incorporating thin ion-selective membranes amenable to galvanostatic operation, as is further described below. The ISEs described herein also respond more rapidly to anion concentration changes and produce less noisy output data than-known ISEs. By employing thin ion-selective membranes, the galvanostatic ISEs disclosed herein operate primarily according to ion transport kinetics rather than thermodynamics of ion binding. The operating principles of the galvanostatic ISEs disclosed herein therefore differ significantly from those of prior known ISEs, requiring new methods of operation and approaches to data interpretation. Thus, the present disclosure provides, first, a brief overview of the structure and basic operating principles of the galvanostatic ISEs, followed by a detailed description of the structure of the galvanostatic ISEs, the method of galvanostatic operation and the interpretation of the data that the galvanostatic ISMs produce.

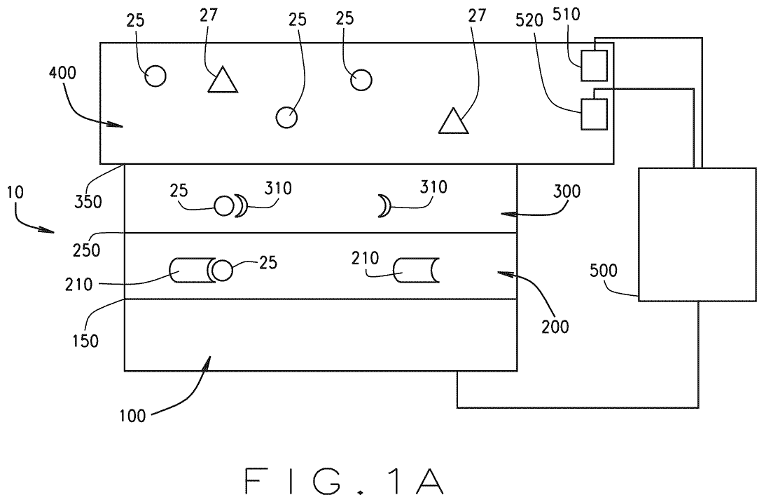

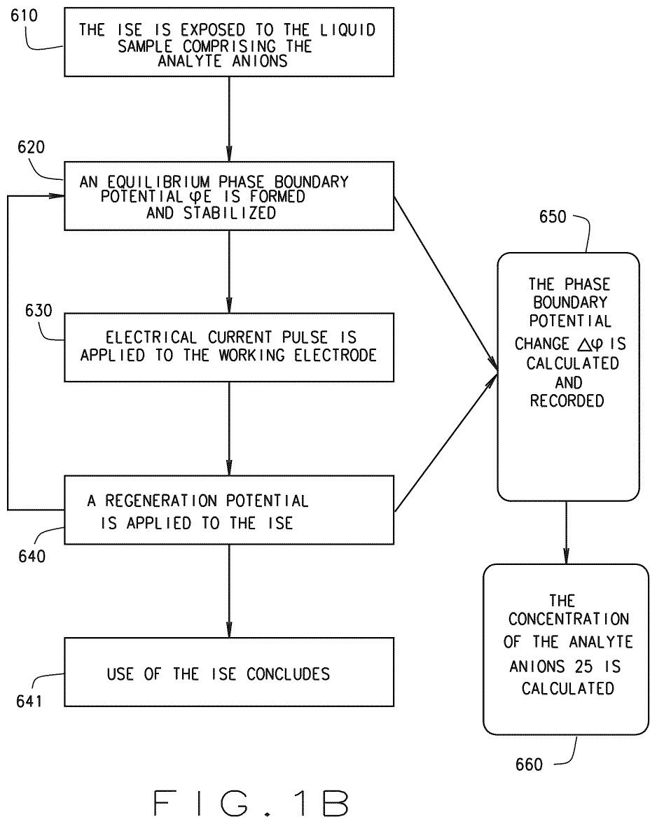

FIG. 1A shows a general structure of a galvanostatic ISE 10, in accordance with various embodiments of the present disclosure. In various instances, the galvanostatic ISE 10 comprises three layers: a working electrode 100, a transduction layer 200 disposed on top of the working electrode 100 defining a transducer-electrode interface 150 therebetween, and an ion-selective membrane (ISM) 300 disposed on top of the transduction layer 200 defining an ISM-transducer interface 250 therebetween.

In various exemplary embodiments, the galvanostatic ISE 10 is used to selectively measure a quantity of analyte anions 25 in a liquid sample 400. The liquid sample 400 is any liquid that comprises analyte anions 25 at a relatively fixed concentration. In various exemplary embodiments, the liquid sample 400 can also comprise a quantity of interferents 27. The quantity of interferents 27 does not affect the operation of the galvanostatic ISE 10 as described herein, but can affect the accuracy of non-selective instruments and methods for the measurement of the concentration of the analyte anions 25. During operation, the galvanostatic ISE 10 is exposed to the liquid sample 400 that comprises a plurality of analyte anions 25. The galvanostatic ISE 10 can be exposed to the liquid sample 400 by any means known to one of ordinary skill, including immersing the ISE 10 in a bulk solution of the liquid sample 400 or by applying a small volume of the liquid sample 400 atop the ISM 300. A sample-ISM interface 350 thus forms between the sample 400 and the ISM 300. Without being bound by any particular theory, an equilibrium concentration of the analyte anions 25 spontaneously forms in the ISM 300 via diffusion and partitioning of analyte anions 25 from the sample 400 through the sample-ISM interface 350. The equilibrium concentration of the analyte anions 25 is stabilized by functional groups 310 in the ISM 300. The equilibrium concentration of analyte anions 25 in the ISM 300 spontaneously creates an equilibrium phase boundary potential (φ_{E}) across the sample-ISM interface 350. Note that the equilibrium phase boundary potential (φ_{E}) does not have to be a measure of the phase boundary potential at a true equilibrium, and a measurement or average measurement of phase boundary potential in semi-stable or other non-equilibrium conditions can be useful as φ_{E}. An oxidizing electrical current is applied to the working electrode 100. The oxidizing electrical current causes the working electrode 100 to oxidize the transduction layer 200, resulting in positively charged moieties 210 in the transduction layer 200. The positively charged moieties 210 in turn attract the negatively charged analyte anions 25 in order to achieve charge neutrality in the transduction layer 200. The analyte anions 25 thus cross from the ISM 300 through the ISM-transducer interface 250 to the transduction layer 200, which in turn draws the analyte anions 25 that are in the liquid sample 400 across the sample-ISM interface 350 and into the ISM 300, causing the equilibrium phase boundary potential φ_{E} to change, resulting in a charged phase boundary potential (φ_{C}) at the liquid sample-ISM interface 350. The phase boundary potential change Δφ is a measure of the difference between the equilibrium phase boundary potential φ_{E} and the charged phase boundary potential φ_{C}. The phase boundary potential change Δφ is therefore a function of the accumulated electronic charges of the analyte anions 25 that cross the sample-ISM interface 350 during the application of the oxidizing electrical current. The measurement of the phase boundary potential change Δφ is interpreted to provide a measure of the concentration of the analyte anions 25 in the liquid sample 400.

A detailed description of the structure of the ISE 10 follows. The working electrode 100 can comprise any electrically conductive structure known to one of ordinary skill in the art. For example, in various exemplary embodiments, the electrode 100 can comprise an electrically conductive metal patterned on an electrically-insulating substrate. In various exemplary embodiments, the working electrode 100 comprises interdigitated gold disposed on a plastic base.

The transduction layer 200 can be any material known to one of ordinary skill in the art to be capable of undergoing redox chemistry to convert ionic current to electronic current. In various exemplary embodiments, the transduction layer 200 can undergo reversible redox chemistry, and thus, after oxidation, the transduction layer 200 can be regenerated via reduction. For example, in various embodiments the transduction layer 200 can be polypyrrole, which can undergo oxidation to form one or more delocalized positive charges that in turn attract a commensurate number of the analyte anions 25 necessary to achieve charge neutrality. In such exemplary embodiments, after oxidation, the polypyrrole transduction layer 200 can undergo reduction to eliminate the one or more delocalized positive charges and release the analyte anions 25 back to the ISM 300 and the liquid sample 400. In various embodiments, the transduction layer 200 can include one or more of polypyrrole, polyaniline, poly(3,4-ethylenedioxythiophene) (PEDOT), polythiophene, poly(3-hexylthiophene), polyindole, polycarbazole, polyfuran, poly(phenylenevinylene), poly(p-phenylene), polyacetylene, any combination thereof, or any other material known to be capable of undergoing redox chemistry to convert ionic current to electronic current.

The transduction layer 200 can be disposed on the working electrode 100 by any means known to one of ordinary skill in the art, including electrodeposition, drop-casting, spin-coating, dip-coating, spray-coating, plasma polymerization, and surface-initiated polymerization, or any combination thereof. The transducer-electrode interface 150 is such that any electrically conductive portion of the working electrode 100 is entirely covered by the transduction layer 200.

The ISM 300 can be any material known to one of ordinary skill in the art to be capable of functioning as a medium through which anions can move to the transduction layer 200. In various exemplary embodiments, the ISM 300 does not comprise a support material such as an epoxy. In various exemplary embodiments, the ISM 300 does not comprise any ionophores and is formed without ion templating. As further described below, the operating principle of the ISE 10 disclosed herein enables the ISM 300 to not comprise a support polymer, an ionophore, or bespoke binding sites generated by the use of an ionic templating method during synthesis of the ISM 300. In various exemplary embodiments, the ISM 300 can comprise functional groups 310 that can aid in the transport of anions via charge stabilization. Thus, in various exemplary embodiments, the ISM 300 can comprise functional groups 310 including amine, hydroxide, pyridinium, imidazolium, pyrazolium, triazolium, pyrrolidinium, piperidinium, benzimidazolium, thiouronium, phosphonium, and sulfonium functional groups as well as any combination thereof. In various exemplary embodiments, the ISM 300 is a polymer or copolymer excluding any ionophore or dopant that is not present in the monomeric species from which the polymer or copolymer is formed. Thus, in various exemplary embodiments, the ISM 300 comprises without limitation polypyrrole, polyaniline, poly(3,4-ethylenedioxythiophene), polythiophene, poly(p-phenylenediamine), polythiourea, polyethyleneimine, poly(allylamine), ethyl cellulose, poly(methyl methacrylate), poly(vinylidene fluoride-co-hexafluoropropylene) (PVDF-HFP), poly(vinyl alcohol), poly(2-hydroxyethyl methacrylate), polyacrylamide, perfluorosulfonic acid ionomer, sulfonated polystyrene (PSS) ionomer, microporous PTFE, or any combination thereof.

Contrary to known ISEs, the ISM 300 of the galvanostatic ISE 10 described herein is applied in a thin layer. For example, in various exemplary embodiments, a thickness of the ISM 300 is less than 100 μm. In various exemplary embodiments, the thickness of the ISM 300 can be between 50 nm and 50 μm, for example less than 50 μm, less than 20 μm, less than 10 μm, less than 5 μm, less than 500 nm, less than 100 nm, less than 90 nm, less than 80 nm, less than 70 nm, less than 60 nm, or less than 50 nm.

In various exemplary embodiments, the ISM 300 is applied to the transduction layer 200 by oxidative molecular layer deposition (oMLD). Thus, in various exemplary embodiments, the ISM 300 can be a highly uniform polymer formed layer by layer to provide a predefined thickness by oMLD. In such embodiments, the ISM 300 can be formed of alternating layers of different polymer materials, such as alternating layers of polythiourea (TU) and para-phenylenediamine (PDA). Layers of different polymer materials can be applied to form the ISM 300 in any conceivable arrangement, including but not limited to A-B-A-B, A-A-B-B, A-A-B-A-A or B-B-A-B-B, where ‘A’ and ‘B’ denote different polymers. Forming the ISM 300 of layers of different polymer materials in predetermined sequence can be used to exert fine control over the rate of movement of various of the analyte anions 25 through the ISM 300, as different analyte anions 25 can exhibit different kinetics when moving through a given polymer material. The ISM 300 can be applied to the transduction layer 200 by any means known to one of ordinary skill in the art.

Referring to FIG. 1B, a flow chart 600 provides a description of the method of pulsed current operation of the galvanostatic ISE 10 follows. Just prior to operation, in a sample exposure step 610, the ISE 10 is exposed to the liquid sample 400 comprising the analyte anions 25, such liquids samples including an aqueous mixture comprising nitrate anions. In various exemplary embodiments, the ISE 10 is exposed to the liquid sample 400 by applying a small volume of the liquid sample 400 to the ISM 300, creating the sample-ISM interface 350. In various alternative embodiments, the ISE 10 is exposed to the liquid sample 400 by immersion. In various embodiments in which the ISE 10 is immersed in the liquid sample 400, the ISE 10 is covered on one or more sides by an insulating material such that the when the ISE 10 is immersed in the liquid sample 400, the liquid sample 400 only directly contacts the ISE 10 at the sample-ISM interface 350 and thus the liquid sample 400 does not directly contact the transduction layer 200 or the working electrode 100. In an equilibration step 620, an equilibrium phase boundary potential φ_{E} is formed and stabilized at a consistent value. The equilibrium phase boundary potential φ_{E} is spontaneously formed as a result of the analyte anions 25 crossing from the liquid sample 400 to the ISM 300 via the sample-ISM interface 350. The equilibrium phase boundary potential φ_{E} is the electrical potential or voltage measured across the liquid sample-ISM interface 350 at open-circuit conditions. The equilibration step 620 has a duration that depends on the composition and thickness of the ISM 300 as well as the mobility of the analyte anions 25 through the ISM 300. However, the thinner the ISM 300, the shorter the duration of the equilibration step 620, and thus the duration of the equilibration step 620 is shorter in the galvanostatic ISE 10 than in typical known ISEs.

The working electrode 100 is connected to an analytical instrument 500, wherein the analytical instrument 500 is capable of both measuring electrical potential (voltage) or electrical current and of applying electrical potential or electrical current of definite magnitude over a definite period of time. Examples of the analytical instrument 500 include a potentiometer or potentiostat. The analytical instrument 500 is also connected to a reference electrode 510 and a counter electrode 520. Both the reference electrode 510 and the counter electrode 520 are disposed in the liquid sample 400. All electrical potential measurements gathered by the analytical instrument 500 are measured between the working electrode 100 and the reference electrode 510. Thus, the reference electrode 510 is positioned relative to the ISE 10 in a manner so as to minimize uncompensated resistance and ensure accurate and stable electric potential measurements. The counter electrode 520, meanwhile, is polarized relative to the working electrode 100 to balance the flow of current into or out of the working electrode 100. Thus, the counter electrode 520 is positioned in a manner to provide efficient current flow without interfering with the electric potential measured between the ISE 10 and the reference electrode 510. The counter electrode 520 is any counter electrode known to one of ordinary skill in the art to be stable and conductive in liquid samples, such liquid samples including aqueous mixtures. In various exemplary embodiments, the counter electrode 520 can be a graphite rod or platinized titanium mesh. The reference electrode 510 is any reference electrode known to one of ordinary skill in the art, regardless of whether the reference electrode 510 has a defined and stable potential (non-polarizable reference electrode), is a pseudo-reference electrode, is a quasi-reference electrode, or another kind of non-equilibrium electrode. The fact that the reference electrode 510 can be a polarizable reference electrode is a unique feature of the galvanostatic ISE 10, as is described below.

To operate the ISE 10, during the equilibration step 620, an operator uses the analytical instrument 500 to measure and record the equilibrium phase boundary potential φ_{E}. Then in a charging step 630 the operator uses the analytical instrument 500 to apply an electrical current pulse to the working electrode 100. The electrical current pulse has a magnitude and a duration sufficient to reversibly oxidize the transduction layer 200, which, as described above, creates the positively charge moieties 210 and thus induces the transfer of a quantity of the plurality of analyte anions 25 across the ISM-transducer interface 250. The movement of the plurality of analyte anions 25 across the ISM-transducer interface 250 generates a charged phase boundary potential φ_{C}, which is the peak potential measured across the sample-ISM interface 350 during the electrical pulse. The magnitude of the electrical pulse can be any value that will reversibly oxidize the transduction layer 200. For example, in various exemplary embodiments, the magnitude of the electrical pulse can be but is not limited to between ≤1 mA and ≤1 μA. However, the magnitude of the electrical pulse can vary due to variables such as the size of the working electrode 100, the ionic conductivities of the ISM 300 and the transduction layer 200, and the electrical conductivities of the working electrode 100 and the counter electrode. The magnitudes of the electrical pulse disclosed herein are merely exemplary and different magnitudes can be envisioned and are considered to be within the scope of the present disclosure.

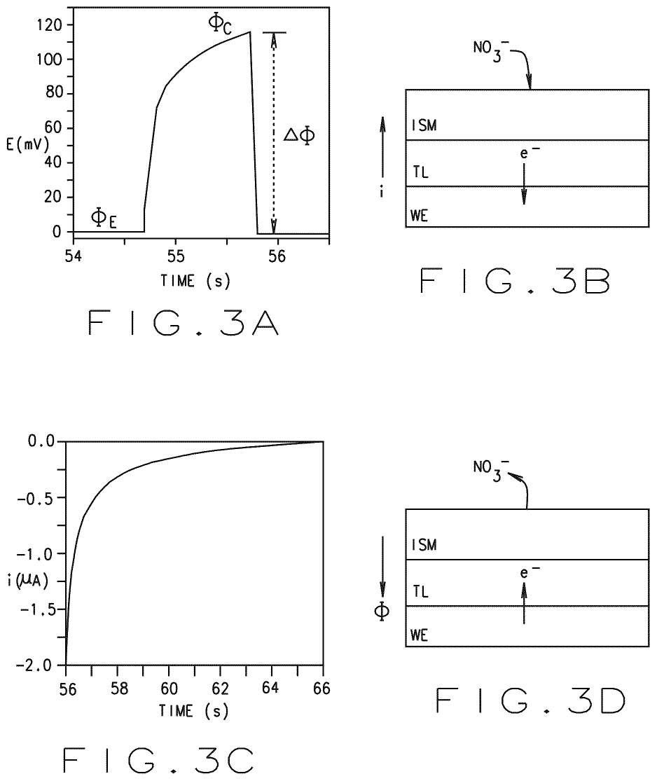

The duration of the electrical current pulse is sufficient to ensure that the charged phase boundary potential φ_{C} is consistent across multiple measurements. As seen in the exemplary voltammogram of FIG. 3A, the increase in measured electrical potential after the onset of the applied electrical current pulse is initially very rapid and then starts to plateau. The duration of the electrical current pulse therefore, in various exemplary embodiments, extends beyond the initial rapid rise in measured electrical potential to thereby achieve relatively consistent measurements of the electrical potential across multiple applied current pulses. Additionally, the duration of the electrical pulse can be determined based on several other variables such as the thickness of the ISM 300, the ionic and electrical conductivities of both the ISE 10 and the liquid sample 400. Thus, in various exemplary embodiments, the duration of the electrical pulse can be between ≤100 ms and ≤10 seconds (s). However, while the durations of the electrical pulse described herein are merely exemplary, different durations can be envisioned and are considered to be within the scope of the present disclosure.

The charged phase boundary potential φ_{C} is measured and recorded during or the charging step 630. FIG. 3A shows an exemplary voltammogram in which electrical potential is measured as a function of time, and in which the electrical current pulse is applied with a one second duration. In a phase boundary change calculation step 650, the phase boundary potential change Δφ is calculated and recorded. As shown by example in FIG. 3A, the phase boundary potential change Δφ is the difference between the equilibrium phase boundary potential φ_{E} and the charged phase boundary potential φ_{C}; that is, Δφ=φ_{C}−φ_{E}.

After the operator uses the analytical instrument 500 to apply the electrical pulse to the working electrode 100, the operator performs a regeneration step 640. In the regeneration step 640, the operator uses the analytical instrument 500 to regenerate the ISE 10 by applying a regeneration potential, which is a reduction potential, between the working electrode 10 and the reference electrode 510 to induce reduction of the transduction layer 200. Reduction of the transduction layer 200 is substantially the reduction of the positively charged moieties 210, which causes the transduction layer 200 to no longer induce the transfer of analyte anions 25 from the liquid sample 400 to the transduction layer 200. Reduction of the transduction layer 200 further results in the transfer of the analyte anions 25 out of the transduction layer 200 through the ISM 300 and into the liquid sample 400, as the liquid sample 400 is most capable of supporting the localized negative charges on the analyte anions 25. The reduction of the transduction layer 200 occurs at an electrical potential that is dependent at least on the composition of transduction layer 200. Therefore a variety of regeneration potentials can be envisioned and are considered to be within the scope of the present disclosure. For example, in various exemplary embodiments, the regeneration potential can be between −0.5 and 0.5 V, for example 0 V. The regeneration potential is applied for a duration sufficient to restore the ISE 10 to an equilibrium condition in which the plurality of analyte anions 25 that were driven into the ISE 10 during the electrical pulse have been driven back into the liquid sample 400. In various exemplary embodiments, the duration of the regeneration potential can be less than between ≤1 s and ≤10 s, although different durations can be envisioned and are considered to be within the scope of the present disclosure. After the regeneration step 640, the operator can conclude use of the analytical instrument 500 in a conclusion step 641 or acquire more data by returning to the equilibration step 620.

Based on the above description, the phase boundary potential change Δφ is not only a measurement of the change in phase boundary potential at the sample-ISM interface 350, but also a measurement of a quantity of the plurality of analyte anions 25 that are driven into the ISE 10 during the application of the electrical pulse. As described below in Examples 1-3, and as exemplarily shown in FIGS. 13 and 14A, experimental data shows a direct and reproducible correlation between the phase boundary potential change Δφ and the concentration of the analyte anions 25, demonstrating that the concentration of the analyte anions 25 in the liquid sample 400 can be calculated and even predicted as a function of the phase boundary potential change Δφ. Thus, in a concentration calculation step 660 following the phase boundary potential change calculation step 650, the concentration of the analyte anions 25 is calculated from the phase boundary potential change Δφ.

As indicated above, in various exemplary embodiments, the reference electrode 510 can be a pseudo-reference electrode, a quasi-reference electrode, or another kind of non-equilibrium or polarizable electrode. The pulsed current operation of the galvanostatic ISE 10 described above enables the use of a polarizable reference electrode 510 because potential drift of the reference electrode 510 is minimal over the duration of the electrical pulse. Small drifts in the potential of the reference electrode 510 can be compensated for during the phase boundary potential change Δφ measurement by comparing multiple sequential applications of the pulsed current and the regeneration potential.

There are several advantages of the galvanostatic ISEs 10 and method of use described herein over ISEs known in the art. For example, ISEs known in the art tend to employ thick ion-selective membranes because they operate passively at open-circuit potentials. At open-circuit potential, there is no applied electric potential to drive analyte ions through the ion-selective membrane. Therefore, in order to avoid inadvertent discharge of ions into liquid sample and out of the ion-selective membranes known in the art, the ISEs known in the art use thick membranes, generally on the order of hundreds of microns thick. Typical thicknesses for ion-selective membranes in ISEs known in the art range from 100 to 300 μm.

Moreover, ISMs known in the art rely predominantly on thermodynamics of ion binding. In other words, the ISEs known in the art employ ISMs that are chemically custom-built to attract and transfer analyte anions via the use of templating or ionophores, and therefore ISMs known in the art are designed to focus on the thermodynamics of ion transfer by increasing binding affinity to the analyte anions. Such ISMs are thus also synthesized to be thick (e.g., 100 μm to 300 μm) in order to avoid inadvertent leaching of ionophores, plasticizers, or other dopants into the liquid sample. Ionophores and other dopants can also compromise the mechanical stability of such ISMs, further encouraging synthesis of thick ISMs in order to compensate for their mechanical fragility. However, the pulsed current operation of the galvanostatic ISE 10 described herein shifts the mechanism of ion transfer from one predominantly driven by thermodynamics to one predominantly driven by kinetics. The emphasis on kinetics over thermodynamics in the galvanostatic ISE 10 described herein allows the ISM 300 to be applied in a thin layer, enabling more rapid transfer of the plurality of analyte anions 25 through the ISM 300. Furthermore, in various exemplary embodiments, as described above, the ISM 300 can be exclusive of ionophores or other dopants and can be synthesized without the use of templating ions. The ISM 300 can therefore exhibit significantly greater mechanical stability than typical ion-selective membranes, obviating any need to apply the ISM 300 in a layer thicker than 100 μm.

Although some efforts have been made to cast traditional ISE membranes at lower thicknesses, such as between 1 μm and 50 μms, such efforts are still plagued by the use of passive open-circuit operation, which requires the integration of ionophores or other dopants in the ion-selective membrane, as described above. The galvanostatic ISE 10 of the present disclosure, by contrast, can exclude such ionophores and dopants, distinguishing the ISM 300 structure from the structures of known ion-selective membranes. As a result, the ISM 300 can be created to be even thinner than the thinnest known traditional ISE membranes.

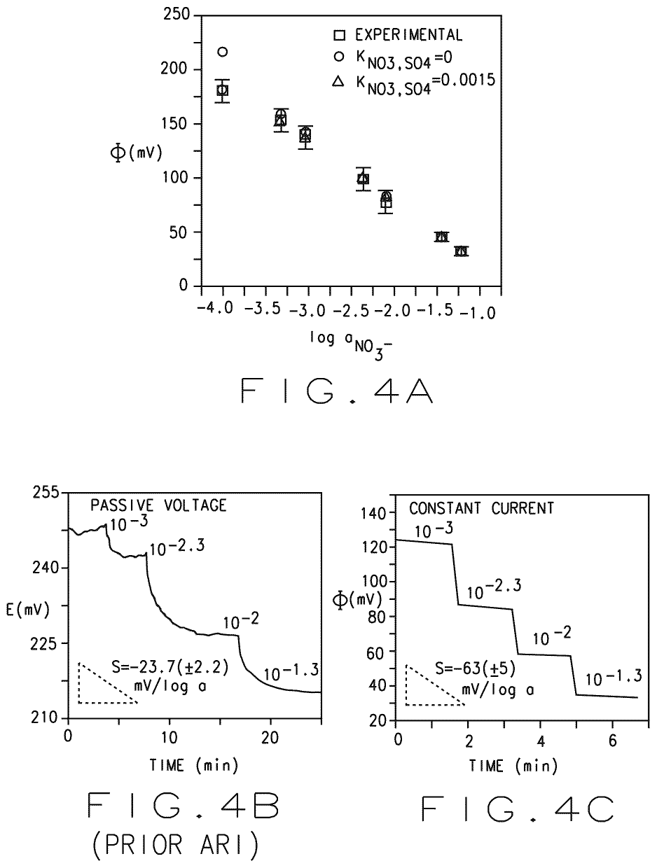

Referring to FIGS. 4B and 4C, as described above, the ISM 300 of the present disclosure is thinner than 100 μm and the galvanostatic ISE 10 undergoes pulsed current operation. This results in unexpectedly rapid and non-noisy measured phase boundary potentials when compared to ISEs known in the art. For example, FIG. 4B shows the measured phase boundary potential of a traditional ISE under passive voltage as a function of time and analyte ion concentration. The phase boundary potential of a traditional ISE is always measured at open circuit potential, and thus the phase boundary potential values shown in FIG. 4B are equilibrium phase boundary potential (φ_{E}) values. As FIG. 4B shows, when using a traditional ISE, changes of less than an order of magnitude in ion concentration require upwards of five minutes to achieve useful equilibration in the measured equilibrium phase boundary potential φ_{E}. By contrast, the measured charged phase boundary potential φ_{C} of an exemplary galvanostatic ISE 10 operating under constant current as a function of time and analyte ion concentration is shown in FIG. 4C. The measured phase boundary potential plateaus within less than one minute, which is extremely rapid when compared to the traditional ISE operated under passive conditions. A comparison of FIGS. 4B and 4C also shows that pulsed current operation of the galvanostatic ISE 10 results in phase boundary potential measurements that have visibly less noise than the phase boundary potential measurements that result from passive control of traditional ISEs.

The emphasis on kinetics over thermodynamics in the galvanostatic ISE 10 described herein also enables the leveraging of statistical methods to interpret data related to a variety of different species of analyte anions 25. Different species of analyte anions 25, having necessarily different sizes and shapes, will exhibit different kinetics of transfer through the ISM 300, and will therefore necessarily engender different phase boundary potential change Δφ values. As a result, the measurement of the concentrations of different analyte anions 25 is also a function of the kinetics of the specific analyte anions 25. As particularly described in Examples 2 and 3 below, mathematical and statistical modeling of the phase boundary potential changes Δφ generated by various different analyte anions 25 at different magnitudes of applied current and different liquid sample concentrations of analyte anions 25 can be used to construct predictive models. Such predictive models can in turn disambiguate the results of the phase boundary potential change Δφ measurements generated by the galvanostatic ISEs 10 described herein in order to simultaneously calculate the concentrations of different analyte anions 25.

The following examples are merely illustrative and provide further detail on exemplary constructions of the ISE 10 as well as methods of use of the ISE 10 in accordance with various embodiments.

### Example 1: Thin-Membrane ISE

Electrochemical Measurements: Electrochemical processes were conducted on a Biologic SP-150 potentiostat, and data acquisition was done using EC-LAB software package. A standard three-electrode setup was used, with 6 mm graphite rod (99.9995%, Alfa Aesar) counter electrode (CE) and Ag/AgCl (SSC) reference electrode (RE, BASi). Polarization curves were obtained by a minimum of 10 repeat cycles of galvanostatic charging for 1 s followed by potentiostatic discharge at 0.0 V vs. SSC for 10 s. Nitrate was spiked in increasing concentration under stirring, and the process repeated. Activity coefficients were calculated according to the Debye-Huckel or Davies formalism as indicated in the main text. Selectivity coefficients were determined using the separate solution method, where coefficients were calculated using the slopes of the response curves when possible or estimated from the difference in potential at the highest tested activity when the slopes differ greatly.

ISE Fabrication: Three different ISM formulations were used in this work: (1) conventional ionophore-based nitrate ISMs, (2) molecularly imprinted nitrate ISMs, and (3) molecularly imprinted phosphate ISMs. Polyvinyl chloride (PVC)-based ionophore ISEs were constructed using gold-coated plastic interdigitated working electrodes (IDEs, Metrohm, P-IDEAU50) due to the facile adhesion of PVC onto these plastic IDEs. PPy films were electrodeposited onto IDEs at a constant potential of 0.8 V for 30 min in an electrolyte of 0.1 M aqueous pyrrole (98%, Alfa Aesar) with 0.1 M NaNO₃ support electrolyte, under continuous UHP argon purge (Airgas). The resulting films were rinsed with methanol (99.8%, Sigma Aldrich) to remove unreacted monomers and dried at 50° C. for 10 minutes to evaporate excess methanol. After PPy electrodeposition, the ISM layer was applied. Conventional ionophore-based nitrate ISM layers were prepared by dissolving nitrate ionophore VI (NIVI, 5.2 wt %), dibutyl phthalate plasticizer (47.1 wt %), tetraoctylammonium chloride (0.6 wt %), and polyvinyl chloride (47.1 wt %) in excess THF. A 30 μL aliquot of the ISM cocktail was pipetted onto the electrode surface, making sure to completely cover the PPy transduction layer. These were then dried in an oven at 50° C. for 10 minutes to remove THE and weighed on a 5-digit precision balance. Average ISM weights based on three electrodes was 2.4 mg.

Molecularly imprinted nitrate and phosphate ISEs employed gold-coated AT-cut quartz crystals (QZ, 5 MHz, Phillip Technologies) as working electrodes. Electrochemical deposition of PPy was carried out at a constant potential of 0.8 V for 2 minutes in an electrolyte of 0.1 M aqueous pyrrole with 0.1 M NaNO₃ support electrolyte, under continuous UHP argon purge (Airgas) to deposit a layer of PPy onto the gold surface of the QZ substrates. Here, only 2 min of electrodeposition were required due to the rapid growth of PPy onto the gold surface of the QZ substrates. Molecularly imprinted ISMs were prepared using methods established previously.^{30,31} Briefly, 100 mmol of 1-Allyl-2-thiourea (98%, Sigma Aldrich) was employed as the functional monomer, with 10.0 mmol of isoamyl nitrate (98%, TCI) employed as the template molecule for nitrate imprinting, and 10.0 mmol of diphenyl phosphate (99%, Sigma Aldrich) employed as the template molecule for phosphate imprinting. The imprinting polymerization reaction was performed by applying 100 mmol ethylene glycol dimethacrylate (98%, Sigma Aldrich) as the backbone polymer to form a network of functional monomers, and 1.2 mmol azobisisobutyronitrile (98%, Sigma Aldrich) as the radical initiator in 4 ml acetonitrile (99.9%, Fisher) as the solvent. To synthesize the polymer, each reaction mixture (containing either nitrate or phosphate template molecules) was prepared using the above material quantities and placed in oven at a temperature of 55° C. for 16 hours. This was followed by a heating step at 80° C. for an additional 3 hours. The resulting polymers were then processed by grinding and sieving. Then, to remove the template molecules, polymer particles underwent a series of washing steps. Initially, a solvent mixture of 500 mL methanol and triethylamine in a 4:1 ratio (v/v) was used, followed by subsequent soaking in pure methanol for 24 hours. Finally, to construct the ISEs, a mixture of 25 mg of imprinted polymer particles and 20 mg of commercial silicone-based epoxy was adhered on the surface of the PPy layer formed on a gold QZ electrode. Control experiments (not shown) for the epoxy resin without the molecularly imprinted polymers (MIPs) did not show selectivity toward any of the anions tested below, making it a viable support material for the MIPs. However, as the epoxy resin cures, all ion transport through the epoxy slows and prevents ISE function. As such, these epoxy-resin supported MIP ISE sensors are only functional for ~3 days, and the data reported for the below sensors was collected within the first 48 hours after sensor fabrication.

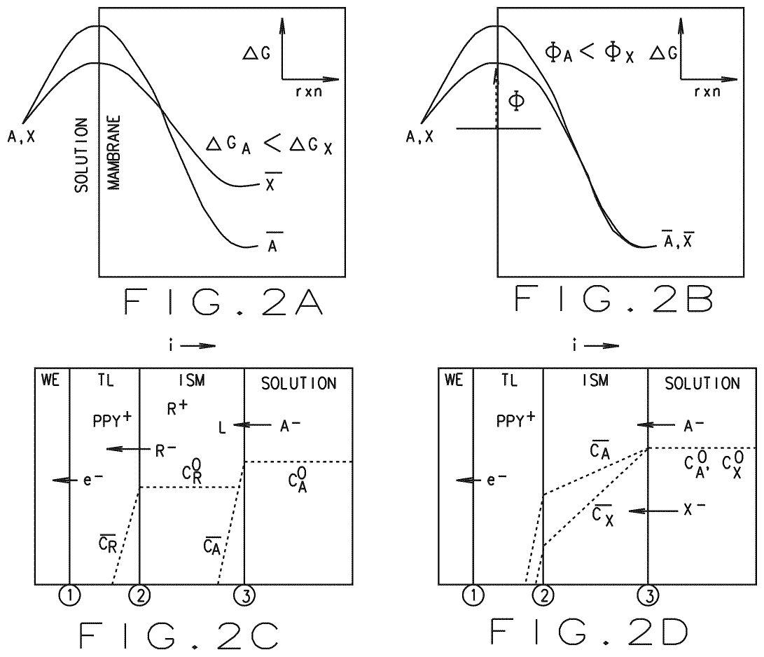

Results and Discussion: Several theoretical treatments of non-equilibrium potentiometry have been previously presented and form the basis of the technique presented here. A formal relationship between current, time, and ion activity for polymeric membranes is derived in the Supporting Information (SI) Section 1. Briefly, Fick's 1^{st} and 2^{nd} Laws are combined with a charge balance and employ the Nikolsky selectivity coefficient to solve for the potential shifts due to interfacial charge separation, membrane composition and charge balances, and electronic voltage drops during galvanostatic polarization. Under these conditions, the final expression for the potential as function of current and time is given by Eqn. 1

$$ϕ = {E}_{( {a}_{A} , i , t )} - {E}_{b} = \frac{R T}{{z}_{A} F} ln [ {a}_{A ( i , t )} + {\sum }_{X} {K}_{A , X ( i , t )} {a}_{X ( i , t )} ] + {B}_{( i , t )} \qquad Equation 1$$

where E is the reported potential, E_{b} is the baseline (stripping) potential, R is the gas constant, F is Faraday's constant, z_{A} and a_{A} are the valency of and activity of analyte A, ax is the activity of interferent X, K_{A,X} is the selectivity coefficient, and B_{(i,t)} is an offset parameter. Note that Eqn. 1 is analogous to the Nikolsky equation for open-circuit potential measurements of mixed solutions of monovalent ions. The measured potential relative to the baseline is thus expected to have similar response curves to those obtained by zero-current potentiometry, provided B_{(i,t)} is constant during measurement conditions. One expects B_{(i,t)} to be a constant if membrane activity and voltage drop are fixed at a given current and time. In other words, in order to obtain a reversible electrode response under applied current conditions, spontaneous discharging of the membrane must be compensated by the charging process (i.e. the membrane activity must be approximately constant). In this context, several noteworthy differences between pulsed current and passive voltage measurements merit discussion. First, if the magnitude and/or duration of the applied current are too short under active measurement, significant polarization of the membrane may not occur, leading to negligible changes in response. Conversely, if the magnitude and duration of the applied current are large under active measurement, the solution|ISM junction can be drained of ions, leading to dielectric potential drop arising from the depletion region and producing a hyper-Nernstian response. This can be largely addressed by using an ionic strength adjustor (i.e. adding a background salt to the measurement solution to ensure the boundary layer is not depleted); however, hyper-Nernstian behavior can still occur if significant migration potentials develop in the membrane during charging. Second, the choice of a stripping potential is somewhat arbitrary, and standard non-polarizable reference electrodes can be replaced with polarizable electrodes provided the RE is over-capacitive compared to the ISE. Finally, the selectivity of the membrane is strongly influenced by the rate of transport across the solution|ISM interface, and the selectivity coefficient is expected to fluctuate with current and/or time. This fact implies that active measurement employs a fundamentally different approach to ion sensing compared to traditional ISE measurements, in which ion transport limitations can take precedence over binding affinity of target analytes to active sites, as outlined in FIG. 2B.

As a test case to examine the above theoretical treatment and demonstrate the benefits of pulsed current non-equilibrium ISE measurement for anion sensors, a thin-film NIVI membrane was used for nitrate detection, as described in the materials and methods section. Here, a PPy transduction layer was employed to absorb the anions under positive electrical potential (oxidation). To obtain reproducible φ vs. t curves, the measurement (charge) step must be followed immediately by regeneration (discharge) step to return the transduction layer to a reduced state. This process can take several minutes under zero-current conditions, and instead controlled discharging at a fixed reducing (or stripping) potential of 0.0 V was opted for (approximately 200 mV more reducing than the equilibrium potential of oxidized Ppy). FIGS. 3A-3D shows sample raw data curves and physical schematics of a typical charging and discharging experiment. Here, the active current measurement consists of two steps: (1) a single pulse of constant current measurement for 1 s, where the shift in potential vs. OCV is tracked during the duration of the measurement, and the overpotential (η) is calculated at the end of this constant current pulse (FIGS. 3A, 3B), and (2) a potential hold at 0.0 V. vs. SSC for 10 s to return the PPy transduction layer to a reduced state (FIG. 3C, 3D).

The reversibility of given charge/discharge cycle can be assessed by calculating the total charge Q transferred during the forward and reverse processes, where Q is directly related to the moles of charge by the Faraday constant F. For the sample data in FIG. 3A, 3B, one calculates a ratio Q_{c}:Q_{d} of 0.98(±0.04) based on five repeat cycles, indicating that ions extracted by a 1 s current pulse are adequately removed by a 10 s discharge at constant voltage. Depending on the choice of material for the transducing layer, the stripping potential used during the regeneration step can impact potential drift. This is due to large changes in conductivity associated with different redox forms of conductive polymers that can lead to large voltage drops and irreproducible measurements. For the polypyrrole transducer employed here, the onset potential for oxidation is roughly −100 mV vs. SSC, and stripping potentials around this value (here 0 mV vs. SSC was used) are appropriate for regenerating the PPy transduction layer between measurements. Notably, over-reduction of PPy may lead to a decrease in the electrical conductivity of PPy that could impede electronic measurements.

To validate the theoretical treatment presented in Eqn. 1, one compares model and experimental response curves in FIG. 4A. Here, several variables related to the geometry and physical properties of the electrode must be known to model the electrode response. Values that could not be calculated were either measured directly or estimated from the literature and are as follows: D=10⁻⁵ cm²/s, D̅=10⁻⁷ cm²/s, R_{T}=3 μmol/cm³, L_{T}=30 μmol/cm³, β_{NO3}=1.4, k_{NO3}=0.00015, k_{CP}=15, ΔV=20 mV, A=0.17 cm², a_{CP}=6 mmol/cm³, and T=300 K. Here D and D̅ are the solution phase and membrane phase diffusion coefficients, respectively, based on molecular dynamics simulations of chloride anions in bulk solution and polymer membranes. R_{T} and L_{T} refer to the ion exchanger and ionophore concentration, respectively, and are calculated based on the percent composition of the membrane, average membrane weight, and estimated membrane density (1.1 g/cm³). The binding constant β_{NO3} was obtained from the sandwich membrane method. The partition coefficients for nitrate anions in the membrane (k_{NO3}) and conductive polymer phase (k_{CP}) were taken from solubility measurements in plasticizer and polypyrrole media. The voltage drop arising from uncompensated resistance ΔV was measured from the polarization curves as indicated in FIG. 3A, and the active area A was determined from the linewidth and spacing of the interdigitated electrode current collectors. The conductive polymer phase activity a_{CP} was estimated from the density and average doping level of electropolymerized PPy. Activities in FIG. 4A were calculated using the Debye-Huckel equation. The model behavior agrees well with experimental data at intermediate to high activity ranges (10^{-3.5}-10⁻¹), with major deviation occurring at low ion activity. One notes that the model predictions in FIG. 4A assumed a selectivity coefficient of K_{NO3,SO4}=0 for this calculation (i.e. no SO₄²⁻ transport through the membrane). However, some co-extraction of the sulfate anion likely occurs at low nitrate activity and would explain the depression of the experimental value below the predicted value. Setting K_{NO3,SO4}=0.0015 provides exact agreement of the model with the experimental data at a_{NO3}=10⁻⁴.

The response characteristics of ISEs under passive conditions are largely influenced by membrane composition, with thinner membranes showing lower sensitivity and detection ranges. Indeed, the nitrate ISE sensors used here which employed a thin ~2 μm NIVI ISM (>100 times thinner than typical NIVI ISM layers) show poor response and long equilibration times under zero-current potentiometry. FIG. 4B shows changes in open-circuit potential with time as the nitrate activity is increased. While the electrodes do respond to changes in activity, the sensitivity (−24 mV/decade) is <50% of the Nernstian slope, and measurements can take several minutes to stabilize. These characteristics are inherent to potentiometric measurements using thin-membrane SC-ISEs, for which no membrane discharge compensation mechanism exists, and response metrics are often poor compared to liquid-contact analogues.

In contrast, the applied current method offers several significantly improved performance metrics in comparison to open-circuit potentiometry. FIG. 4C shows the results of galvanostatic polarization of the same electrode over the same activity range shown in FIG. 4B, where the lines plotted for each indicated activity represent 10 consecutive pulsed current measurement cycles. The data in FIG. 4C indicates that instrumental control of the electrode system allows for a drastic reduction in equilibration time. Defining the equilibration time as the time needed for the potential drift to stabilize within 1 mV/min following each activity increase, an average equilibration time of 174 s (2.9 min) was calculated for the passive measurements in FIG. 4B compared to 10 s using galvanostatic measurement in FIG. 4C. This is especially crucial in long-term studies or continuous monitoring applications where large fluctuations in potential could compromise measurements. Moreover, pulsed current detection facilitates faster response times by driving the ion flux at the solution|ISM interface, enabling the >10-fold decrease in equilibration times between FIGS. 4A and 4B. This is particularly advantageous in dynamic systems where rapid changes in ion concentrations occur. Here, active pulsed current control is used to tune the ISE system such that membrane self-discharge is adequately compensated and the phase boundary activity is representative of the bulk.

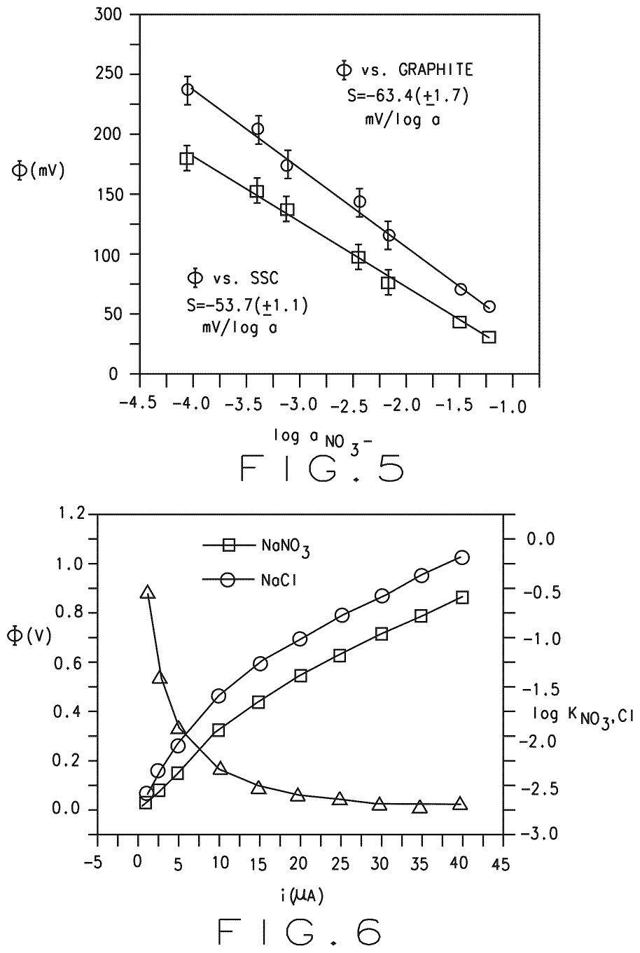

Another advantage arises from the pulsed current measurement approach. Because the analytical signal employed here is the differential potential measured relative to baseline as opposed to a standardized reference potential, ideal REs can be replaced with lower-cost alternatives. High capacitance materials undergo minimal potential shifting at low charging currents, and the resulting signal is dominated by changes at the WE. This concept is shown in FIG. 5 in which the nitrate response using a graphite rod as a reference electrode is similar to that observed using a SSC reference. One emphasizes the practical benefit indicated by the data presented in FIG. 5, where potential drift of the reference is inconsequential. This is because the measurement under active ISE measurement is of the polarization potential (also sometimes referred to as overpotential) during electrode charging (φ) over a short (~1 s) timescale, rather than the open circuit potential vs. a reference over a longer timescale. Any drift in the reference potential is subtracted during the overpotential measurement using two steps of pulsed current (measurement) and reducing potential (regeneration) steps. One notes that a shift in calibration offset is expected when comparing measurements between SSC and graphite REs, as the uncompensated resistance will be different between these two reference electrodes with different geometries. Indeed, FIG. 5 shows a 12(±4) mV change in offset between REs. This difference constant at fixed current and time, however, and does not reduce the measurement sensitivity. The results of FIG. 5 are interesting for several reasons. The ability to use over-capacitive REs allows for reduction in ISE complexity, eliminating associated issues like RE storage, electrolyte leakage, and potential drift. Additionally, simplified (e.g. carbon) RE materials allow for alternative configurations and geometries if the cumbersome liquid-contact RE can be eliminated. Lastly, standard reference electrodes (like SSC) are expensive, and replacement of these electrodes with cheaper constituents can significantly reduce the cost of ISE systems.

In addition to response characteristics, the selectivity coefficient K_{A,X} varies with current and time for ions with different lipophilicity. Assuming Eqn 1. holds for all anion species X, the selectivity of the SC-ISE can be calculated using the separate solution method. FIG. 6 shows the results of pulsed polarization in separate solutions, in which the selectivity improves with increased current to a limiting average value of 0.002 on the 10-20 μA range. Unfortunately, depletion effects occur at these higher currents, and to avoid depletion, the current should be limited to the 2-4 μA range, for which one measures K_{NO3,Cl}=0.02. While the electrode response is excellent in this range, typical open-circuit K_{NO3,Cl} values for NIVI-containing ISM's range from 0.006-0.01 depending on the methods involved. This indicates that some selectivity is sacrificed using the thin NIVI membranes with pulsed current measurement compared to thick NIVI membranes with passive measurement. One attributes this reduced selectivity of these NIVI-based ISEs under pulsed current operation to the fact that the applied polarization helps drive interfering ions through the membrane without the assistance of the ionophore or ion-exchange mechanisms. One notes that the ionophore-based NIVI ISM formulation here employed has been previously engineered for its ion binding affinity to nitrate, but this is not the operative property that governs selectivity in pulsed current operation.

In typical passive ISE operation, membrane selectivity is determined largely by the binding affinity between the target ion, the interfering ion, and the ionophore or active site. When an external electric field is employed, differences in ion transport become significant, allowing for the selective transport of target ions through the membrane. The use of applied current as a mechanism for selectivity based on differences in ion transport opens a new landscape of membrane designs. Materials with inherently slower ion transport rates, previously deemed impractical, can now be useful as ISE components. By using applied current to accelerate ion transport, these materials can potentially offer higher selectivity factors without compromising sensitivity and response time. This principle is illustrated in FIG. 2D, where ions having higher mobility will move through the membrane with higher flux, and will have higher concentrations in the membrane during polarization, and therefore a less drastic voltage shift during galvanostatic charging. In other words, it is differences in solid state diffusivity through the membrane that govern ion selectivity under active current measurement. Solid state ion diffusivity through membranes is a kinetically limited process, arising from energy barriers for ion hopping through the solid, and is not governed by the thermodynamics of ion solubility in the membrane.

This realization that the membrane selectivity under active measurement is governed by differences in ion transport kinetics rather than ion binding thermodynamics in the ISM has a meaningful impact on sensor design. Specifically, it means that materials need not necessarily be engineered to have favorable thermodynamics for binding a target anion to be useful as membrane materials in ISEs. Instead, if different ions experience different transport behavior through a given material, this material can be used as a membrane material in an ISE sensor under pulsed current measurement. To test this conclusion, the NIVI ionophore membranes used above were replaced with a nitrate-templated ethylene-glycol dimethacrylate and allyl thiourea (MIP-N) MIP membrane material. This MIP-N powder was blended within an epoxy suspension matrix, and constructed into a PPy/MIP-N ISE according to the methods section. Briefly, allyl thiourea monomers serve as active sites for templating of nitrate-selective sites into the MIP-N polymer based on hydrogen bonding interactions. These monomers are coordinated to an organo-nitrate (isoamyl nitrate, IAN) during synthesis, and crosslinked in place with poly-ethyelene glycol dimethacrylate. The IAN is then removed, leaving nitrate templated sites in the polymer. The polymer is suspended in an epoxy matrix and cast onto PPy-coated gold surfaces of QZ electrodes. This type of MIP-N material has been shown to uptake nitrate ions by impedimetric methods where enhanced mobility of the templated ion through the material was used to measure the nitrate concentration in test solutions. Based on the previous demonstrations that nitrate transport is enhanced in this MIP-N over other anions, one would expect these MIP-N membranes to also be functional in active ISE measurements. The MIP-N membranes have several distinctive differences from plastic membranes discussed earlier. First, the crosslinked active sites are immobilized in an epoxy matrix, in contrast to the freely moving ionophore sites in a plastic membrane. Second, the MIP-N membranes do not contain an anion exchanger salt, and thus the ion exchange mechanisms utilized by plastic membranes are not available. This means that MIP-N sensors operate by a different mechanism from the mechanism described in FIG. 2C, where ions must traverse the membrane during charging in order to maintain current flow, and the results of Eqn. 1 must be modified to account for membrane diffusion and migration contributions. The final voltage response in this case is given by Eqn. 2, where steady-state conditions were assumed for solving the Nernst-Plank equation. Higher currents are needed to sufficiently polarize the MIP-N sensors compared to the plastic membranes, and the concentration of ionic strength adjustor was set to 0.1 M Na₂SO₄ to limit interfacial potential drops. As such, the Debye-Huckel treatment of activity is no longer appropriate, and all following activities were calculated using the Davies equation. The potential drop is described by Equation 2:

$$ϕ = {φ}_{( {a}_{A} , i , x )} - {E}_{b} = \{ \frac{R T}{{z}_{A} F} - \frac{i x}{{μ}_{A} {z}_{A} FA [ {\overline{a}}_{A ( x )} - {\overline{a}}_{A ( 0 )} ]} \} ln [ {\overline{a}}_{A ( 0 )} ] + {B}_{( i )} \qquad Equation 2$$

In Equation 2, here φ is the diffusion-migration potential, x is the membrane thickness, μ_{A} is the mobility of ion A, B₍ᵢ₎ is constant for a fixed current, and bar accents above activities a denote membrane phase concentrations, which will be dependent upon bulk solution phase concentrations. It follows that for ions with high mobility, the second term in the curly brackets of Eqn. 2 will be small, and a quasi-Nernstian response will be obtained. As the mobility decreases significantly, the second term in the curly brackets of Eqn. 2 will become dominant, requiring a higher potential to sustain a specified current. Treating the transport of multiple ions across the membrane as a group of parallel resistors, the highest mobility ion will dominate the potential drop behavior for a given ISE operated under pulsed current.

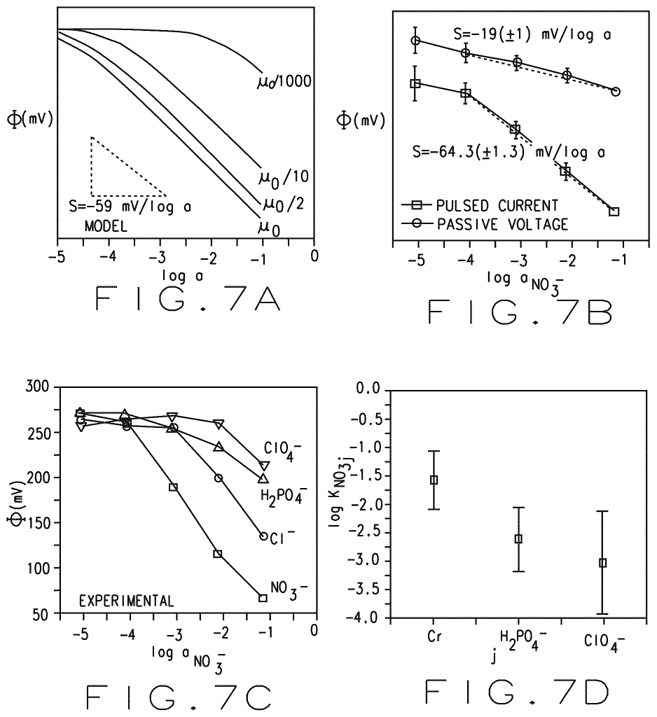

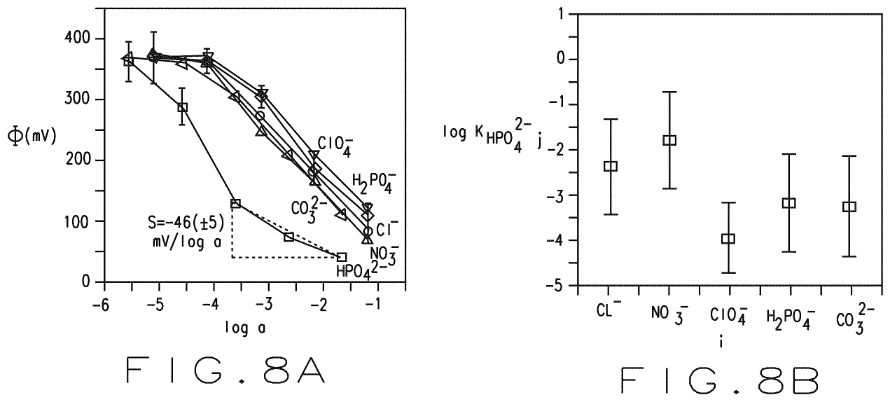

In FIGS. 8A-8D, the model predictions from Eqn. 2 were compared against the performance of ISMs fabricated using the MIP-N ISM. FIG. 7A shows the prediction based on Eqn. 2 for φ vs. log(a) for ions with different mobilities. The responses using pulsed current measurement for different anions with a MIP-N ISE sensor in FIG. 7B agree with these qualitative trends, indicating that μ_{NO}_{_{3̅}}>μ_{C̅l̅}>μ_{H̅2}PO₄>μ_{ClO}_{_{4̅}} for MIP-N, where μ_{ClO}_{_{4̅}}≅μ_{NO}_{_{3̅}}/1000. In FIG. 7C, the responses for nitrate using passive vs. active measurements were plotted. Similar to the thin NIVI ISMs, the MIP-N membranes exhibit sub-Nernstian responses under passive voltage conditions, making it difficult to separate ion insertion processes from other surface charge contributions to the measured voltage. This response is greatly improved by utilizing the pulsed current method, with near-Nernstian responses to nitrate activity observed at 3 μA input signal (FIG. 7C). The depressed response curve for passive measurement in FIG. 7C despite ISM thicknesses >100s of μm suggests that the nitrate-thiourea complexation constant for these membranes is low. Despite this weak complexation interactions, control of interfacial transport via applied current overcomes these inherent thermodynamic limitations, providing a near-Nernstian response under pulsed current measurement conditions.

As expected, the influence of transport phenomena on sensitivity extends to selectivity for the MIP-N sensors as well. This point is illustrated in FIG. 7D, where a comparison of separate solution calibrations of the MIP-N sensors to nitrate analyte and chloride, monobasic phosphate, and perchlorate interferents is shown. These interferents were examined to test the effects of ionic radius and geometry on selectivity. The nitrate and chloride anion have roughly the same radius (179 μm) but planar and spherical geometry, respectively. Monobasic phosphate and perchlorate both have pyramid geometry, but significant differences in covalent radii (200 and 250 μm, respectively). The MIP-N sensors show large overpotentials in the presence of these interferents when compared to nitrate. These overpotentials arise from the additional energy required to move the interfering ions through the MIP-N ISM, suggesting that the templating procedure indeed provides a coordination network that facilitates transport of the nitrate ions. The larger interference effect of the Cl⁻ relative to ClO₄⁻ and H₂PO₄⁻ suggests that the source of ion selectivity in MIP-N may arise from size-exclusion effects.

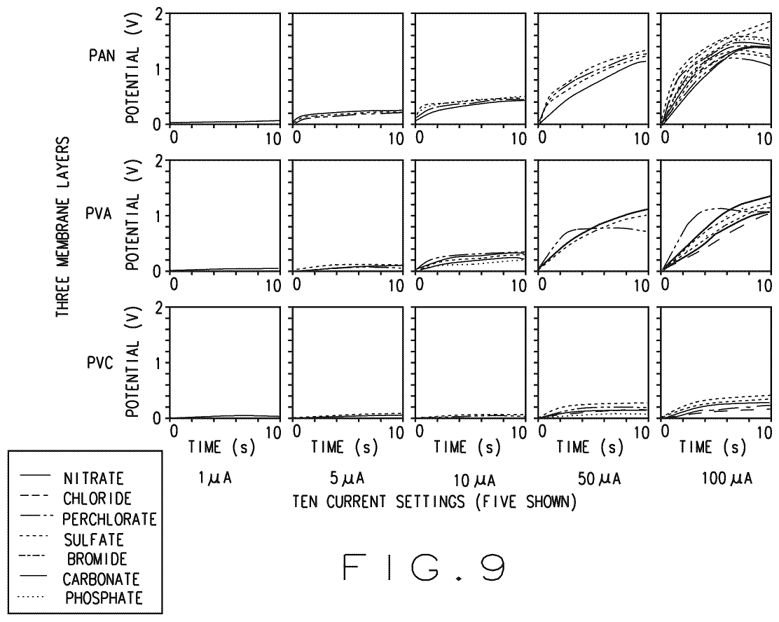

The selectivity values in FIG. 7D are comparable to commonly reported values for ionophore-based nitrate ISEs operated under zero-current potentiometry with the exception of the perchlorate response. The perchlorate anion is a major interferent for most nitrate ISEs due to the high binding constant of perchlorate to the nitrate ionophore. In contrast, the MIP-N sensors are highly discriminate against perchlorate (K_{NO3/ClO4}=0.001 vs. K_{NO3/ClO4}=−300 for NIVI). This suggests a membrane network well templated for nitrate transport, but ill-suited for transport of ions with different geometry. The advantage of such a transport-controlled sensor is that it offers a different mode of selectivity without the need for specialized ionophores, provided coordination environments and pathways can be introduced via an appropriate template molecule during the membrane synthesis. Based on the proof-of-concept demonstration for MIP-N above, one expects that the templating procedure used to produce the MIP-N membranes could be extended to other species. To show this, membranes were synthesized using the same formulation as that in FIGS. 8A-8D but replaced the isoamyl nitrate template with diphenyl phosphate to make phosphate templated sensors (MIP-P). Sensitivity and selectivity curves using the combined MIP-P sensors and galvanostatic detection are shown in FIGS. 9A-9B.

Unlike the plastic membrane and MIP-N sensors, the MIP-P sensors exhibit deviations from the Nernstian response described in Eqn. 2 for both monobasic and dibasic forms of phosphate. Qualitatively, the response of the MIP-P sensors to monobasic phosphate is similar to that of the MIP-N sensors for nitrate, however, the slope of the linear region indicated in FIG. 8A is hyper-Nernstian. As the background electrolyte activity is quite high, the hyper-Nernstian response is not likely the result of phase boundary depletion, and there are other more plausible explanations. Simultaneous coextraction of background electrolyte and analyte can lead to hyper-Nernstian behavior under passive conditions, and it is possible that this phenomenon is occurring during membrane charging. For dibasic phosphate, there is a non-linear region at low activity coupled with a hyper-Nernstian region at higher activity (note that for an ion of −2 charge, Eqn. 1 predicts a response of −30 mV per decade). Interestingly, the potential response to dibasic is lower than that of monobasic phosphate by ~100 mV, indicating preference of the MIP-P electrode for this ion form. The nonlinear trend for dibasic phosphate in FIG. 8A can be explained in terms of pH changes occurring in the test solution during analyte addition (see SI Section 4 for more detail). At low activity (~10⁻⁵), 80% of the phosphate is in the monobasic form. As the activity of dibasic phosphate (black curve) is increased to 10⁻³, the pH increases rapidly, and dibasic phosphate becomes the dominant form, and a linear response is obtained beyond this point. The slope of the dibasic phosphate curve is approximately half that of monobasic phosphate, indicating transport of a −2 charged ion. In contrast, the monobasic form is dominant for all data points on the corresponding curve in FIG. 8A.

Similar to MIP-N sensors, the selectivity of MIP-P sensors was determined by separate solution calibration with nitrate, chloride, perchlorate, and carbonate interferents (FIG. 8B). Selectivity factors were calculated by Eqn. 3.

$$log {K}_{i , j} = \frac{{z}_{i} ( {ϕ}_{j} - {ϕ}_{i} )}{S} + log \frac{{a}_{i}}{{a}_{j}^{{z}_{i} / {z}_{j}}} \qquad Equation 3$$

Here i refers to dibasic phosphate (HPO₄²⁻), j is the interferent, S is the slope indicated in FIG. 8B, activities aᵢ and aⱼ were taken from the highest dibasic phosphate activity (10^{-1.6}), and potential φⱼ was calculated at log aⱼ=−1.6 by linear fits to each interferent curve. The MIP-P sensors show no selectivity to monobasic phosphate over the interfering ions, meaning that the templating procedure produced a highly non-specific coordination environment for the monovalent form. The sensors do however show high selectivity for divalent phosphate, which suggests that the valency is influencing phosphate transport through the polymer matrix. The diphenyl phosphate template molecule employed during phosphate templating is expected to produce tetrahedral coordination of three R—P—O···H−N−R hydrogen bonding interactions (with isoamylnitrate) and one R−P−O−H···O−R hydrogen bonding interactions (with ethylene glycol dimethacrylate) in the MIP formulation. The dibasic form of phosphate (P(OH)O₃²⁻) reflects the same quantity and type of hydrogen bonding interactions as expected for diphenyl phosphate, whereas the monobasic form (P(OH)₂O₂⁻) has a mismatch in the hydrogen bonding interaction types and quantities. The rejection of carbonate, another divalent anion, by the MIP-P electrodes may be explained by the different geometry (trigonal planar) and different quantity and type of intermolecular hydrogen bonding interactions relative to the template molecule.

### Example 2: Multi-Electrode Array

Electrode Fabrication: An AT-cut quartz crystal with a 5 MHz frequency, gold-coated and sourced from Phillip Technologies, was mounted on a QCM-200 controller (Stanford Research Systems) and used as the substrate. PPy (99%, Sigma Aldrich) was electrodeposited onto the gold-coated quartz surface by applying a constant potential of 0.8 V (vs. Ag/AgCl) for 2 minutes in an aqueous solution (18.2 Mohm deionized water) containing 0.1 M pyrrole and 0.1 M sodium nitrate (99%, Fisher) as the supporting electrolyte. The deposition process was carried out under continuous UHP argon purge (Airgas). After deposition, the resulting PPy film was rinsed with methanol (99.8%, Sigma-Aldrich) to remove any unreacted monomers. The film was then dried at 50° C. for 10 minutes to evaporate excess methanol.

Polyacrylonitrile (PAN), polyvinyl alcohol (PVA), and polyvinyl chloride (PVC) were each dissolved in their respective solvents: dimethylformamide (DMF) for PAN, methanol for PVA, and dimethyl sulfoxide (DMSO) for PVC that demonstrated adequate solubility, spin-coating behavior, and aqueous stability for further development in the sensor platform. The concentration of each polymer solution was 10 mg of polymer per 10 mL of solvent (1 mg/mL). A volume of 150 μL of each polymer solution was then applied to the surface of the PPy-coated electrode. The polymer films were spin-coated onto the PPy layer using an SPIN150 spin coater (SCS). In the spin coating process, the substrate was spun at 1000 rpm for 40 seconds, followed by 3000 rpm for 10 seconds. The polymer films were then subjected to acetone to remove any of the excess monomers that were not on the substrate then dried with argon (Airgas).

Electrochemical Measurements: Pulse current measurements were conducted to evaluate the electrochemical response of the polymer-coated PPy electrodes when exposed to the solutions containing seven anions: nitrate (NO₃⁻), chloride (Cl⁻), perchlorate (ClO₄⁻), sulfate (SO₄²⁻), bromide (Br⁻), carbonate (CO₃²⁻), and hydrogen phosphate (HPO₄²⁻). Each anion solution was prepared at three concentrations: 0.1 M, 0.001 M, and 0.00001 M.

The response of the electrodes was measured through a two-step pulse current procedure. In the first step, a single pulse of constant current was applied anodically for 10 seconds, during which the potential shift relative to the open-circuit voltage (OCV) was recorded. The overpotential (η) was determined at the end of the pulse to evaluate the sensor's electrochemical response to each anion. In the second step, the same current was applied cathodically for 10 seconds to discharge the system, reducing the PPy layer back to its initial state. This discharge step ensured the reproducibility of the measurements and reset the sensor for subsequent testing.

Pulse current measurements were performed at 10 discrete current levels, ranging from 0.1 μA to 100 μA. For each current level, potential-time responses were recorded as the polymer/PPy-coated electrodes were exposed to different anions at varying concentrations. This procedure enabled direct comparison of potential responses across concentrations at each applied current.

To further investigate the environmental relevance of the sensor, additional experiments were conducted on mixed ion solutions. These tests focused on three anions of environmental importance: NO₃⁻, Br⁻, and HPO₄²⁻. Mixed solutions were prepared using the concentrations described in Table 1, and the pulse current method was applied as described above. This focused analysis allowed for a more realistic evaluation of the sensor's performance in complex ionic environments relevant to water quality monitoring.

TABLE 1
Concentrations of the mixed anionic solutions

| NO₃_{^{−}} (M) | Br⁻ (M) | HPO₄²⁻ (M) |
|---|---|---|
| 3.0 × 10⁻² | 3.0 × 10⁻⁶ | 6.0 × 10⁻⁴ |
| 2.0 × 10⁻⁴ | 1.0 × 10⁻² | 3.0 × 10⁻⁶ |
| 3.0 × 10⁻⁶ | 5.0 × 10⁻⁴ | 4.0 × 10⁻² |
| 4.0 × 10⁻² | 8.0 × 10⁻² | 3.0 × 10⁻² |
| 1.0 × 10⁻⁴ | 7.0 × 10⁻⁴ | 8.0 × 10⁻⁴ |
| 6.0 × 10⁻⁶ | 3.0 × 10⁻⁶ | 4.0 × 10⁻⁶ |

Machine Learning Implementation: ML techniques were applied to predict the concentration of anions based on electrochemical response of polymer-coated PPy electrodes across various current levels. The implementation was carried out using the Scikit-learn library in Python, where four models-Linear Regression (LR), Decision Tree (DT), Random Forest (RF), and Multilayer Perceptron (MLP)—were employed to build predictive frameworks. To assess the performance of readily available, user-friendly tools, these models were used in their default, unoptimized configurations as provided by Scikit-learn. LR served as a baseline model, while DT and RF captured nonlinear trends, and MLP addressed more complex patterns. To ensure robust and unbiased performance, a 5-fold cross-validation strategy was applied, where the dataset was split into five subsets, and each subset was used as a test set once while the remaining subsets were used for training. Model performance was assessed using Absolute Percent Error (APE) and Pearson Correlation to evaluate prediction accuracy. This approach demonstrates the utility of accessible, out-of-the-box ML tools for analyzing electrochemical data and shows their potential for broader adoption without requiring extensive optimization.

Results and Discussion: Pulsed Current Results: As shown in FIG. 9, the electrochemical responses to pulse currents reveal significant differences in behavior across the various anions and polymer-coated electrodes. PAN produced the most intense electrochemical responses, exhibiting the highest r, followed by PVA, with PVC generating the smallest responses. This trend suggests that PAN interacts more strongly with anions than PVA and PVC.

These observations are based on a comprehensive experimental dataset, comprising 21 different experiments across 9 different electrodes, with triplicate measurements, amounting to a total of 1,890 runs. The large dataset ensures that the results are statistically robust, providing a reliable basis for understanding the response patterns across the various polymer-anion interactions.

Furthermore, FIG. 9 highlights that as the applied current increases, the electrochemical responses become more irregular and less predictable. This increasing variability indicates that the interactions between the polymer surface and the anions become more complex at higher currents. These irregularities suggest a nonlinear behavior that is more pronounced with higher current levels.

The distinct and varying responses observed across different polymer materials (PAN, PVA, and PVC) and current settings provide a strong basis for the application of ML techniques. The unique electrochemical signatures of each polymer-anion combination, along with increasing irregularity at higher currents, present valuable data for predicting ion concentrations and optimizing sensor performance in complex environments. These findings underscore the potential of ML to enhance the accuracy and sensitivity of electrochemical sensors.

The electrode responses at a constant current of 0.01 μA were analyzed across different ion concentrations and polymer compositions to evaluate their distinct behaviors. The responses for PVC-based electrodes exhibit a clear trend: the lowest ion concentration produces the highest response, while the highest concentration yields the lowest response in potential versus time measurements. This inverse relationship between ion concentration and electrode responses indicates that PVC exhibits a heightened sensitivity to variations in concentration, potentially due to its specific ion-polymer interactions or intrinsic material properties.

In contrast, electrodes fabricated with PVA and PAN show relatively stable responses across all tested concentrations. However, the ordering of the anion responses varies between concentrations, suggesting that these materials enable unique anion-specific trends. This variability across polymers indicates that each material interacts with ions differently at various concentrations, providing a distinct fingerprint for each polymer-concentration combination. These findings highlight the potential for ML techniques to distinguish and classify these nuanced trends effectively. By leveraging the unique response patterns of each polymer, ML methods can enhance the interpretation of complex ion-electrode interactions, paving the way for robust analytical tools in chemical sensing.

Simulation of Data: Due to the unique response observed in the initial stages of the study, it was decided to use the existing dataset alongside the ML models as described earlier. This decision stemmed from the realization that the sparsity of the original dataset rendered its direct use impractical for further analysis. Consequently, focus shifted to investigating whether the concept of an electronic tongue, leveraging non-templated polymers, could serve as a plausible sensor. Building upon this idea, the dataset mentioned previously was used as a basis set, given that it represents individual anions interacting with polymer-based electrodes.

Upon analyzing the dataset, it was observed that the response curves exhibited a pattern resembling that of an RC circuit. This prompted us to use apply Kirchoff's voltage law, as expressed in Equation 4:

$$V ( t ) = {I}_{0} R ( 1 - {e}^{- \frac{t}{R C}} ) \qquad Equation 4$$

Here, it was determined the time constant (T) by solving for the point at which the output voltage reached 63% of its final maximum potential (Vₘₐₓ), as shown in Equation 5:

$$τ ( t ) = {V}_{max} \times 0.63 \qquad Equation 5$$

To further analyze the system, the hypothetical resistance (R) was calculated using Equation 6, where I represents the current applied during data collection:

$$R = \frac{{V}_{max}}{I} \qquad Equation 6$$

Subsequently, the capacitance (C) was determined by substituting the calculated τ into Equation 7.

$$C = \frac{τ}{R} \qquad Equation 7$$

These derived parameters enabled us to simulate a scenario in which anions interacted with the polymer-electrode surface under idealized conditions. The simulated RC circuit values were then compared with experimental data. While the simulated and experimental results aligned to a significant extent, some deviations were observed, likely attributable to the complexities inherent in real-world applications.

Using the calculated R and C values, the data was interpolated to generate synthetic datasets. This allowed us to investigate the number of data points required to train a robust ML model capable of accurately sensing these anions. Since the basis dataset included three distinct concentrations, the R and C values were plotted on a graph and fit a polynomial to interpolate intermediate values along the observed curves.

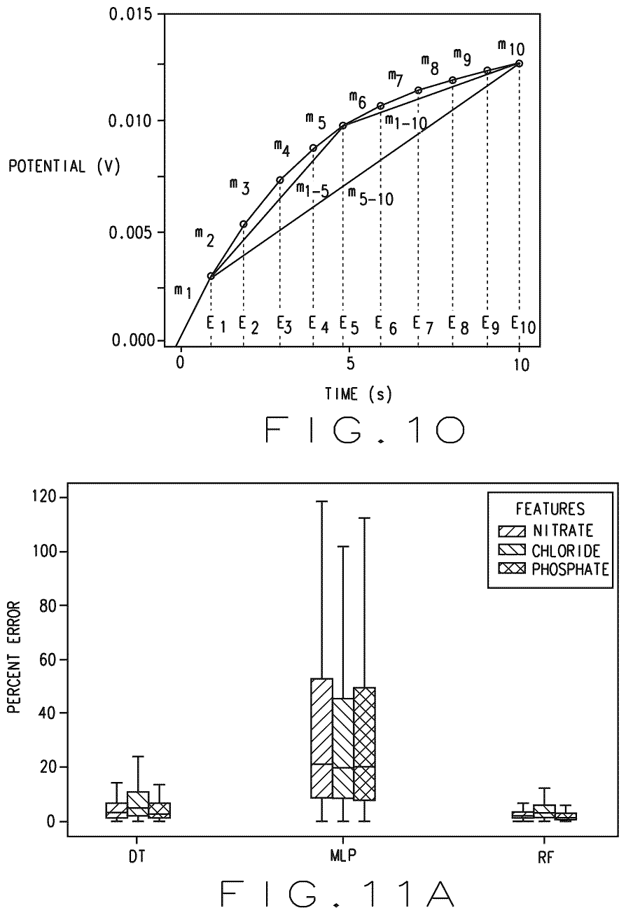

Rather than simulating the entire synthetic potential versus time curves, it was decided to featurize the data in a way that effectively captured its most critical elements. A key part of this process was selecting specific time points at which to extract potential values, represented as E₁ through E₁₀ in FIG. 10. These time points were chosen because they provided a systematic way to capture the dynamic changes occurring throughout the anionic exchange. By examining the potential at each second over a ten-second interval, both rapid changes and slower trends in the system were adequately represented. These points offered a balance between granularity and simplicity, allowing us to capture temporal variations without overwhelming the analysis with unnecessary data.

Additionally, the slope changes were calculated at each second, providing insights into how quickly the potential was evolving at a fine-grained level. To complement this, the overall slope changes were calculated across broader intervals: 1-5 seconds, 5-10 seconds, and 1-10 seconds. This hierarchical approach allowed us to capture both short-term fluctuations and long-term trends, ensuring a comprehensive characterization of the system's behavior. By focusing on these features, the most relevant aspects of the data were distilled while avoiding the complexity of simulating the entire curve.

Initially, it was assumed that the dataset comprised triplicate electrodes, with three electrodes per polymer fabricated and measured under identical conditions and therefore suitable to be treated as experimental replicates. However, further analysis using a Pearson correlation matrix revealed that this assumption did not hold. Instead of exhibiting strong positive correlations, as would be expected from true replicates, the matrix indicated that the electrodes displayed substantial variability, with several pairs even showing weak or negative correlations. This result suggests that, despite nominally identical processing, the electrodes behaved as distinct samples rather than replicates. Such discrepancies may arise from subtle differences in film deposition, polymer morphology, or electrode surface interactions that affect the electrochemical response. Consequently, the dataset effectively contained nine unique electrodes, each with its own characteristic's behavior. This finding prompted a critical reassessment of the analysis approach, as treating these electrodes as replicated would obscure meaningful variability and potentially mislead downstream interpretation.

Following the realization that the electrodes could not be treated as true replicates, focus was placed on the variance within the Pearson correlation matrix for each electrode-polymer combination. In this context, variance reflects the degree of variability in how individual electrodes correlate with response variables across the dataset. High variance in the correlation matrix suggests that electrodes within a given combination produce more diverse and less consistent responses, likely capturing a broader range of underlying system behaviors. It was hypothesized that selecting electrodes from combinations with the highest correlation variance would provide more unique and informative data, enhancing the ability of the machine learning model to learn nuanced patterns and make accurate predictions. Consequently, PAN electrode 03, PVA electrode 01, and PVC electrode 01 were identified as the electrode-polymer pairs with the greatest variance in their internal correlations These were selected as the “best” candidates for machine learning input, as their pronounced variability is expected to improve the model's capacity to generalize across complex system behaviors.

With these high-variance electrodes selected, they were integrated into the ML model. These electrodes, with their pronounced variability, would provide the most informative data, contributing to more accurate and reliable predictions. By incorporating these high-variance electrodes into the ML model, the aim was to capture the dynamics of the system in a way that would not have been possible using less variable data. This approach enhanced the quality and relevance of the predictions, ensuring that the model was trained on the most representative and informative portions of the dataset.

Building on this foundation, simulated 500,000 experiments. By varying new combinations of ion concentrations through interpolation a vast range of experimental conditions were generated. These combinations were produced randomly, ensuring an unbiased and comprehensive exploration of the parameter space. The entire simulation process was completed in just six hours, highlighting the remarkable computational efficiency of the method. This stands in stark contrast to the months of labor required to obtain the original 21 experimental data points using traditional methods. The substantial reduction in time, combined with the ability to explore a much broader range of conditions, underscores the significant advantages of simulation-based methods for data generation and analysis.

A range of ML algorithms were employed to evaluate their predictive capabilities and determine the most suitable model for the data. The primary focus was comparing the performance of various algorithms, including LR, MLP, DT, and RF. To assess the accuracy of each model, the APE, a metric that quantifies the accuracy of predictions by measuring the absolute different between the predicted and actual values, was used, expressed as a percentage of the actual value. This approach allows for a direct comparison of the error rates across different models, highlighting their effectiveness in capturing the true patterns within the data.

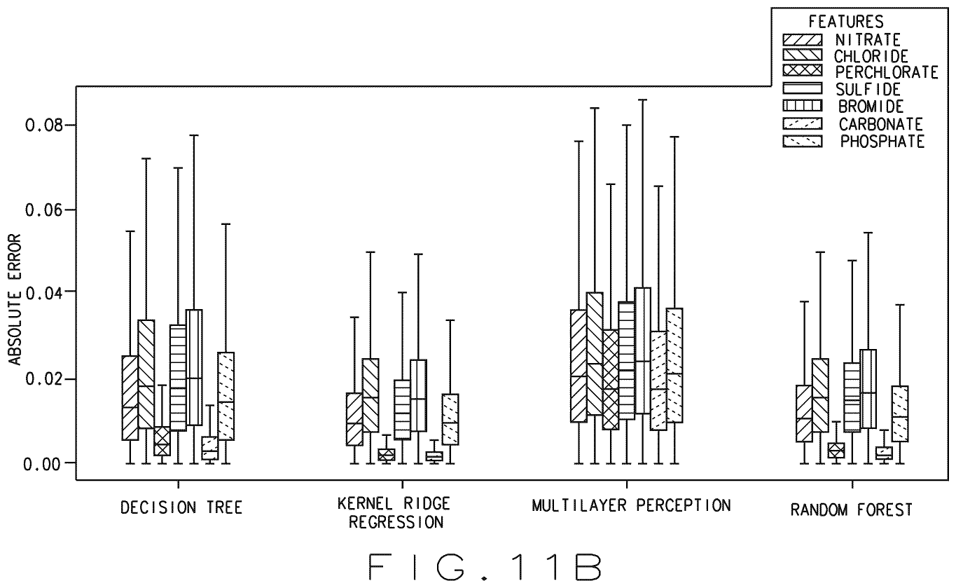

FIG. 11A presents the results of the “bake-off” between the three ML algorithms, comparing their predictive accuracy based on 25,000 experiments sampled from the full synthetic dataset. The comparison demonstrates that the RF model consistently outperforms the others, achieving the lowest APE values across all three ion combinations. This suggest that RF is the most accurate model for capturing the underlying relationships within the data. In contrast, the MLP and DT models exhibit higher APE values, indicating that they are less precise in their predictions compared to RF. The consistently superior performance of RF underscores its effectiveness in this context. These results reinforce the reliability of the RF model, establishing it as the preferred choice for analyzing anion concentrations and their interactions.

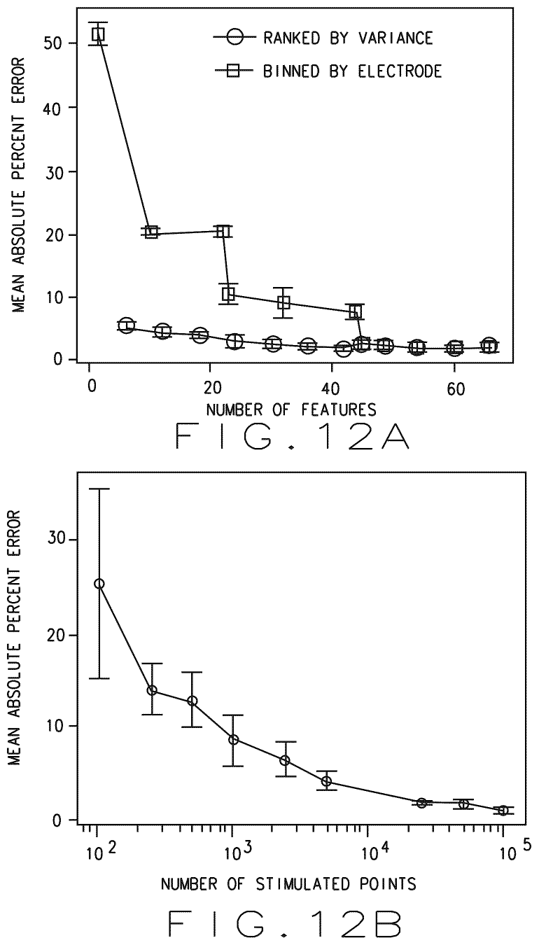

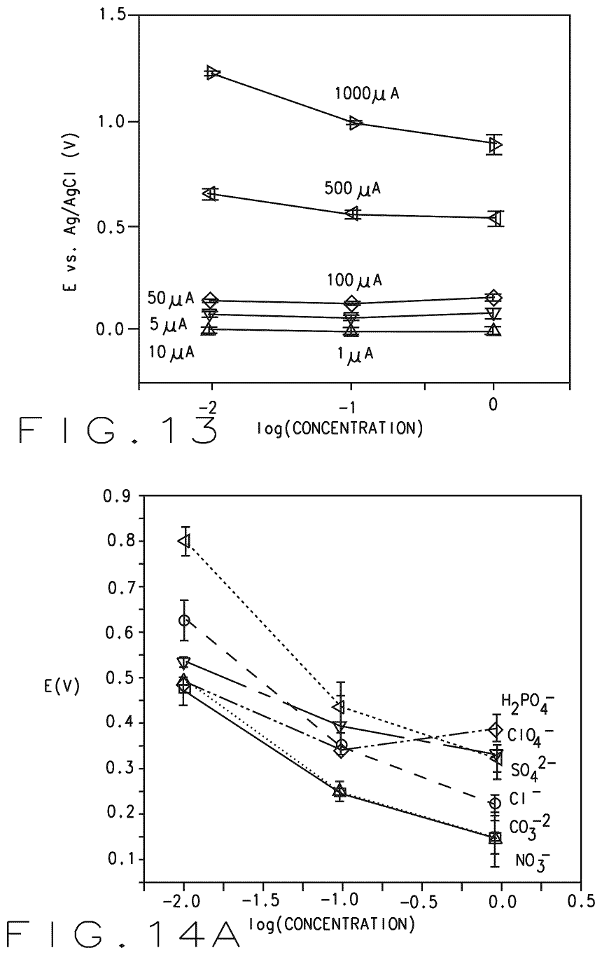

In FIG. 12A, it was demonstrated that utilizing responses from multiple electrodes yielded better results compared to using responses from individual electrodes. By aggregating the responses across multiple electrodes, a more comprehensive set of data was captured, leading to improved model accuracy. The integration of these multi-electrode features was performed systematically, as described in Table 2, to maximize the contribution of each feature to the overall model performance. This approach enabled us to better understand the system's underlying behavior by combining the complementary data from different electrodes.

TABLE 2
Integration of Multi-Electrode Features

| PAN01 | PVA03 | PVC01 |
|---|---|---|
| Slope 1 to 2 | Potential E2 | Slope 9 to 10 |
| Slope 1 to 5 | Potential E3 | Slope 8 to 9 |
| Slope 1 to 10 | Potential E4 | Slope 7 to 8 |
| Slope 2 to 3 | Potential E5 | Slope 6 to 7 |

Through this process, it was determined that the optimal number of features for the model was 42, as adding more features beyond this point did not provide a substantial improvement in predictive accuracy. Moreover, using features ranked by variance led to a lower mean absolute percent error (MAPE) more quickly compared to features binned by electrode. The MAPE was calculated by combining the errors from each anion and producing a single point of error for the model. The chloride anion contributes to a higher error across all models, raising the average error per ion. This observation emphasizes the need to carefully consider the contributions of specific ions to the overall error and highlights the importance of choosing the right features to minimize error.

In the case of individual electrode-polymer combinations, PAN electrode 01's top features primarily corresponded to the overall slope of the response curve. This suggests that PAN 01 is particularly sensitive to the slope changes throughout the experiment, making it more useful for identifying time-dependent trends. For PVA electrode 03, the most significant features were derived from the early portion of the potential curve, highlighting its role in detecting early-stage changes in the system's behavior. In contrast, PVC electrode 01's key features were predominantly located in the later portions of its slope, making it more sensitive to the final stages of the response.

One working hypothesis is that PAN's distinct slope-driven behavior could be related to the electron-withdrawing nature of its cyano groups. As the applied current increases during the charging process, these groups may influence charge redistribution in a way that enhances anion transport or expulsion, resulting in more influential overall potential changes. It's important to note that all measurements were taken during the charging phase only; no discharging behavior was used within this dataset. For PVA, the early-stage features may reflect the activity of carboxylic acid groups, which could be more reactive or proton donating under these conditions, influencing the potential response before full polarization occurs. PVC may behave similarly at later timepoints, possibly due to its less polar, more inert surface, although the underlying mechanisms are still not fully clear.

Ultimately, the results emphasize that using multiple electrodes with varied responses provides a more effective strategy than relying on a single electrode-polymer combination. By incorporating responses from different electrodes, each contributing unique information, a wider range of system dynamics was captured, leading to improved model performance. This multi-electrode approach not only enhanced the model's ability to discern complex relationships but also reinforced the importance of diversity in electrode responses. Leveraging this diversity allows for a more robust and accurate model, ensuring that one can better predict ion concentrations and their interactions, which would not be possible with a single electrode-polymer combination alone.

Number of simulated points: Building on the findings from FIG. 12A, where the advantage of utilizing responses from multiple electrodes to improve model accuracy was depicted, the influence of dataset size on the model's predictive performance was investigated. Using the optimal set of 42 features identified in the previous analysis, the MAPE was systematically evaluated across datasets of varying sizes to determine the minimum number of simulated data points required to achieve a reasonable error while avoiding unnecessary computational overhead. This step was critical to ensure the practical applicability of the approach for real-world scenarios.

FIG. 12B illustrates the MAPE calculated for various dataset sizes, ranging from 100 to 100,000 simulated experiments. The dataset sizes tested included the following values: 100, 250, 500, 1,000, 2,500, 5,000, 15,000, 50,000, and 100,000. For datasets containing 100 to 500 data points, the MAPE remains above 10% error, indicating that these smaller datasets are not sufficient for achieving reliable model accuracy. This limitation is likely due to the model's reduced ability to effectively sense chloride ions, which may not be fully captured with smaller datasets. However, once the dataset size reaches 1,000 data points, the error drops significantly, falling below the 10% threshold. Notably, the dataset with 5,000 data points performs at an error rate under 5%, indicating a more efficient level of data, as further increases in data points provide diminishing returns in terms of error reduction.

At 15,000 data points, the error drops further, reaching below 2%. While this represents a significant improvement in accuracy, the computational time required to process such a large dataset was exponentially longer, highlighting the trade-off between accuracy and efficiency. These findings suggest that while larger datasets can lead to better model performance, there is a practical point-such as around 5,000 data points—where the error becomes sufficiently low and the computational burden remains manageable.

The original experimental dataset, resulting in one million synthetic data points where each of the seven electrolytes had concentrations ranging from 0.1 M and 0.00001 M. To determine which ML algorithm would work the best experiments were run on only 1% of the data-one hundred thousand data points- to evaluate the performance of the various ML algorithms. The algorithms that were tested upon were decision tree (DT), polynomial kernel ridge regression (KRR), multilayer perceptron (MLP), and random forest (RF). To ensure a thorough assessment, these algorithms were evaluated using five-fold cross-validation, which helped manage data variability and ensure proper shuffling. The results in FIG. 12B indicate that all models achieved under 1% absolute error when predicting the concentration of each electrolyte.

### Example 3: oMLD Growth of ISMs

Oxidative molecular layer deposition (OMLD) was employed to directly deposit thiourea-functionalized polymer films onto polypyrrole without the need for epoxy adhesives. This gas-phase, layer-by-layer deposition technique enables precise control over membrane thickness and composition while providing uniform, conformal coatings on the electrode surface. The oMLD approach significantly improves the reproducibility of membrane fabrication and eliminates epoxy-related interference, resulting in more stable and reliable sensor performance.

To monitor mass changes during the oxidative molecular layer deposition (oMLD) growth using thiourea as the monomer and MoCl₅ as the oxidant, in situ quartz crystal microbalance (QCM) measurements were performed.

Unlike the ideal self-limiting behavior typically observed in ALD, an initial mass loss upon thiourea dosing, followed by a plateau and a subsequent mass gain toward the end of the exposure period were observed. Conversely, for the MoCl₅ exposure, there is a clear mass gain during the dosing period, followed by a plateau during the purge step. The initial mass loss can be attributed to the desorption of physisorbed species and the evolution of HCl, produced by the reaction of thiourea with residual surface-bound Cl species originating from the preceding MoCl₅ half-cycle. The subsequent mass plateau likely reflects a transitional period during which incoming thiourea molecules begin to interact with oxidized thiourea species already present on the surface. As dosing continues, the system exhibits a non-self-limiting mass increase, which can be explained by the oxidative dimerization of thiourea to form non-volatile formamidine disulfide species on the surface, allowing multilayer buildup rather than monolayer saturation. Additionally, physisorption of excess thiourea onto the surface and previously adsorbed layers may contribute to the continued mass increase with extended dosing times. This behavior indicates that under the conditions employed, the growth mechanism shifts from a strictly surface-limited ALD regime to a partially non-self-limiting, CVD-like growth mode, governed by continuous surface reactions and physisorption phenomena during thiourea exposure. For Conversely, during the MoCl₅ exposure step, the QCM data reveal a continuous mass gain throughout the dosing period without reaching a stable plateau during the subsequent Ar purge. This behavior indicates ongoing adsorption of MoCl₅ onto the surface, where the precursor molecules react with available nucleophilic sites such as amine or thiol groups from the previously adsorbed thiourea layer. The substantial molecular weight of MoCl₅ (273.2 g/mol) contributes to the pronounced mass increase observed during this step. However, unlike typical ALD processes characterized by self-limiting surface reactions, the mass signal does not stabilize, indicating that the surface sites are not saturated under the chosen exposure conditions. Instead, the continuous mass gain suggests a non-non-self-limiting reaction, where the MoCl₅ adsorption proceeds beyond monolayer coverage, potentially resulting in multilayer growth or physisorption.

To understand the mass uptake behavior during deposition, at different cycle numbers in situ QCM measurements were performed to track the mass gain (ng/cm²) versus dose time for thiourea and MoCl₅ exposures. FIG. 2a presents the mass gain versus time over 100 ALD cycles, showing a continuous increase in total mass with each cycle. After approximately 20 cycles, the growth-per-cycle (GPC) stabilizes at around 168 ng/cm² per cycle.

This behavior is characteristic of the two-phase growth typically observed during atomic-layer deposition (ALD). At the start of deposition, the growth is influenced by the starting surface, and the process parameters can vary from cycle to cycle. This initial period is commonly referred to in the ALD literature as the “nucleation” phase, during which the surface chemistry gradually evolves toward a uniform reactive surface. Once the influence of the starting surface subsides, the reaction mechanism stabilizes, and the GPC becomes nearly constant. According to the data, this transition to a steady-growth regime occurs after approximately 20 cycles, confirming the establishment of steady-state growth under the deposition conditions.

Each measurement was collected under identical dosing and purging conditions to isolate the evolution of mass changes with increasing cycle number. During thiourea dosing, an initial mass loss was observed followed by a plateau and then a mass gain near the end of the dose period. Additionally, as the cycle number increases (e.g., cycle 20 compared to cycles 1, 2, 5, and 10), the onset of mass gain occurs at approximately the same time. In the MoCl₅ dosing traces, a clear increase was observed in the overall mass gain as the cycle number increases. The increasing mass gain with cycle number may be attributed to reduced diffusion of MoCl₅ through the film, leading to greater accumulation near the surface during the dose. These trends indicate the growth mode transitions from initial nucleation-dominated behavior to film-controlled growth with increasing cycles.

Sensitivity and selectivity measurements: It was previously demonstrated that membrane sensitivity under active current measurements in ISEs is governed primarily by ion transport kinetics rather than thermodynamic ion binding. Specifically, molecularly imprinted polymer membranes (MIP-N) incorporating allyl thiourea monomers as functional sites for nitrate were employed, using hydrogen bonding interactions to template nitrate selectivity during synthesis. Under applied current, ions with higher solid-state diffusivity through the membrane exhibited higher flux and concentration during polarization, resulting in smaller voltage shifts during galvanostatic charging. This framework allowed us to exploit transport differences, rather than binding affinity differences, to achieve selectivity under active measurement conditions.

In this work, oxidative molecular layer deposition (oMLD) was adopted to deposit thiourea as the functional monomer onto electrode surfaces, addressing these reproducibility and longevity challenges. Similar to a previous approach, thiourea monomers were selected due to their potential to form hydrogen bonds with nitrate ions, providing active sites for nitrate recognition. However, in this study, a templating molecule during polymerization was not used. This decision allows us to systematically evaluate the intrinsic sensitivity and selectivity of thiourea-functionalized membranes toward nitrate ions relative to other common anions, without the influence of molecular imprinting.

To systematically evaluate the sensitivity and selectivity of the anion sensor under non-equilibrium conditions, a series of current pulses of varying magnitudes (1, 5, 10, 50, 100, 500, and 1000 μA) was applied to the sensor while measuring the resulting potential response. These measurements were performed to force the flux of ions from the sample side toward the polymeric membrane and quantify the resulting phase boundary potential shifts under active current control. As shown in FIG. 13, increasing the applied current leads to a clear increase in the potential shift across the sensor. At lower current magnitudes (1-100 μA), the potential increases gradually with increasing current, while at higher currents (500 and 1000 μA), a more pronounced jump in the measured potential was observed. This trend indicates that larger current magnitudes enhance ion flux across the sensor-solution interface, resulting in higher potential signals and increased selectivity for nitrate over chloride. At the highest applied currents, the significant increase in potential can be attributed to drain ions from the solution and sensor interface junction, leading to dielectric potential drops arising from the depletion region and producing a hyper-Nernstian response consistent with prior reports on phase boundary depletion under strong polarization. Additionally, under these strongly polarized conditions, the system may approach the potential required for undesired water splitting (~1.23 V vs Ag/AgCl), which can introduce additional interference and instability in the potential signal. To avoid these depletion and water-splitting effects while still achieving enhanced selectivity, 100 μA was identified as the optimum applied current for subsequent experiments.

According to previous findings, under pulsed current operation, ions with higher mobility within the membrane will exhibit higher flux and concentration during polarization, resulting in smaller voltage shifts during galvanostatic charging. This behavior reflects differences in solid-state diffusivity within the membrane, which becomes the dominant factor governing ion selectivity under active measurement conditions. The lower potential shifts observed for nitrate relative to other anions (except carbonate) in FIG. 14A suggest that nitrate exhibits higher mobility through the thiourea-functionalized membrane. FIG. 14B quantifies this behavior by displaying the selectivity factors for each anion, calculated using Equation 8:

$$log {k}_{i j} = \frac{{Z}_{i} ( {Q}_{j} - {Q}_{i} )}{s} + log \frac{{a}_{i}}{{a}_{j} \frac{{z}_{i}}{{z}_{j}}} \qquad Equation 8$$

Here, K_{i,j} represents the selectivity factor of ion i over ion j. The terms zᵢ and zⱼ denote the charge of ion i and ion j, respectively. The symbols Qᵢ and Qⱼ correspond to the measured potentials for ion i and ion j. The variable S refers to the slope of the calibration curve, expressed in mV per decade. Finally, aᵢ and aⱼ represent the activities of ion i and ion j, respectively. To investigate the nitrate selectivity of oMLD-deposited thiourea sensors under active current measurement, potentiometric measurements were performed under an applied galvanostatic current of 100 μA. Sensors were fabricated using 100 s dosing and 100 s purging steps for both thiourea and MoCl₅ at 140° C.

Shown in FIG. 14A are the potential shift response curves measured during pulsed current charging in solutions containing four different anions-nitrate (NO₃⁻), chloride (Cl⁻), carbonate (CO₃⁻²), dihydrogen phosphate (H₂PO₄⁻), perchlorate (ClO₄⁻), and sulfate (SO₄⁻²) at concentrations of 0.01 M, 0.1 M, and 1 M.

Error bars in FIG. 14B represent sample standard deviations derived from two independently prepared electrodes, with two measurements performed on each electrode under the same conditions. The observed low selectivity of the thiourea-based oMLD sensors for nitrate over carbonate can be attributed to the similarities in the geometry and charge distribution between CO₃⁻² and NO₃⁻. Both ions exhibit trigonal planar geometries with approximately 120° bond angles and delocalized negative charges across their oxygen atoms, facilitating efficient transport through the thiourea-functionalized membrane under applied current conditions. This structural similarity likely results in comparable ion mobility within the membrane, reflected in the low absolute selectivity factor (log k_{NO3-, CO3-2}=−0.29), indicating that the sensor exhibits limited discrimination between nitrate and carbonate.

Additionally, the higher selectivity of nitrate over chloride (log K_{NO3-, Cl-}=−2.5) can be rationalized by considering the hydrogen bonding interactions within the membrane. Unlike nitrate, chloride cannot engage in hydrogen bonding with the thiourea moieties, reducing its transport efficiency and interaction strength within the sensor membrane. This reduced mobility under polarization conditions leads to a larger potential shift for chloride compared to nitrate, resulting in enhanced selectivity for nitrate over chloride in the active current sensing configuration. All three ions (H₂PO₄⁻, SO₄⁻², and ClO₄⁻) exhibit tetrahedral geometry, which can also be described as pyramidal due to the spatial arrangement of the oxygen atoms around the central atom. Notably, ClO₄⁻ has a larger ionic radius (~250 μm) compared to H₂PO₄⁻ and SO₄⁻². This larger size and distinct geometry relative to the planar structure of nitrate (NO₃⁻) reduces the mobility of perchlorate within the thiourea-functionalized membrane under pulsed current operation. As a result, the sensors demonstrate better selectivity for nitrate over perchlorate compared to the other anions tested.

To evaluate the impact of deposition temperature on the sensing performance of polythiourea-coated polypyrrole electrodes, oxidative molecular layer deposition (oMLD) of polythiourea on top of electrochemically deposited polypyrrole films at 130° C., 140° C., and 150° C. was performed. The deposition was conducted using 100 s thiourea dosing and 100 s argon purging for 250 cycles, followed by sensitivity and selectivity measurements using nitrate and chloride ions at concentrations of 0.01 M under a range of applied currents (1, 5, 10, 50, 100, 500, and 1000 μA).

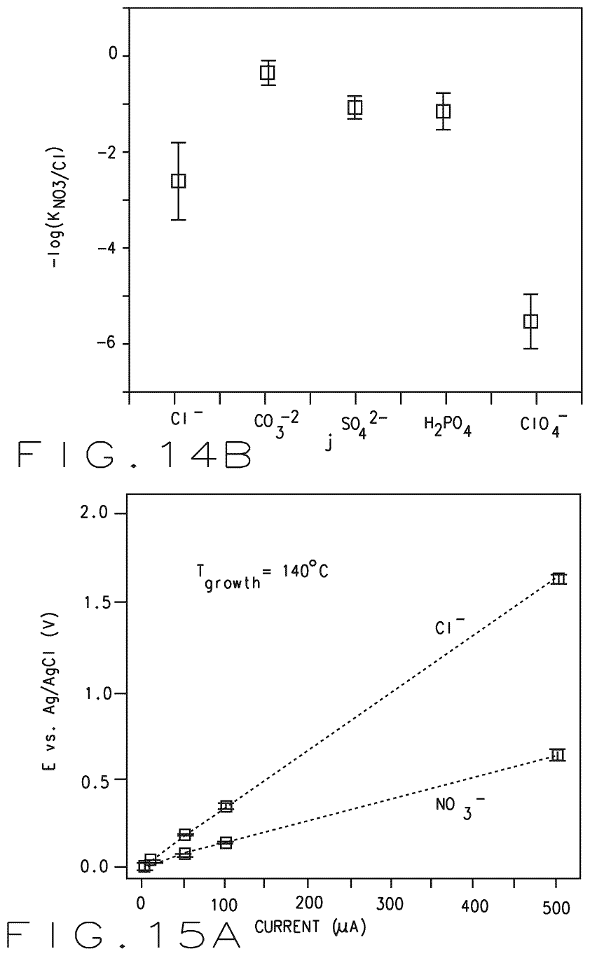

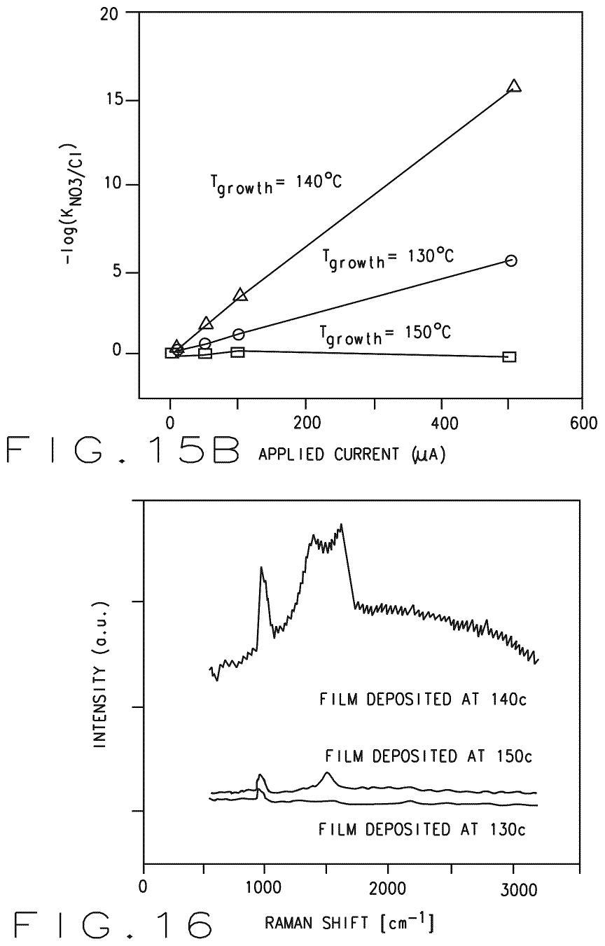

Shown in FIG. 15B is the potential shift for the sensors where polythiourea film was deposited at 140° C. As you can see, the potential response for chloride is higher than nitrate. As the applied current increases, the potential shift between nitrate and chloride generally increases for all sensors, consistent with the expected enhancement in ion flux and potential separation at higher currents. Ions with higher mobility in the membrane matrix move more efficiently under applied current, leading to higher flux and greater accumulation within the membrane during galvanostatic polarization. This in turn causes a less drastic potential shift, since the mobile ion can more readily compensate for the imposed current. Therefore, the ion with lower mobility in the membrane dominates the voltage rise, producing a higher potential response during galvanostatic charging. This is because the limited transport leads to faster ion depletion and sharper potential changes. The observed higher potential response for chloride compared to nitrate suggests that nitrate has higher mobility in the deposited polythiourea film. This could be due to stronger hydrogen bonding interactions or better alignment with the polymer structure, which facilitates nitrate transport across the membrane more effectively than chloride.

To investigate the effect of deposition temperature on the chemical structure of the films, Raman spectroscopy was performed on samples deposited at 130° C., 140° C., and 150° C. Shown in FIG. 16 are the corresponding Raman spectra, where the blue, red, and black traces represent the films deposited at 130° C., 140° C., and 150° C., respectively. Spectra were collected under identical conditions to allow for accurate comparison.

All spectra show a distinct peak in the 935-940 cm⁻¹ range, attributed to N—C—N stretching vibrations. Specifically, this peak appears at 937 cm⁻¹ for 130° C., 940 cm⁻¹ for 140° C., and 939 cm⁻¹ for 150° C., indicating the presence of a common structural unit in the polymer backbone across all samples.

Beyond this, several temperature-dependent features were observed. The peak at 659 cm⁻¹ in the 140° C. sample exhibits noticeably higher intensity than in the other two and is assigned to the C═S stretching vibration, suggesting stronger thiocarbonyl bonding or improved organization at this temperature. Additionally, a peak at 1374 cm⁻¹ appears prominently in the 140° C. sample and is attributed to NH₂ rocking vibrations-likely arising from unreacted thiourea residues remaining in the film. The 150° C. sample displays a peak at 1485 cm⁻¹, which corresponds to C—N stretching, while a broader feature around 1599 cm⁻¹, observed in multiple samples, may be indicative of N═N bond formation between monomers.

Taken together, these spectral features suggest that while the N—C—N framework is preserved across all deposition conditions, other functional groups evolve with temperature. The enhanced C═S signal at 140° C. and the appearance of NH₂ and C—N related peaks at higher temperatures indicate subtle chemical changes, possibly due to variations in polymerization extent or side reactions. The presence of an N═N feature at 1599 cm⁻¹ further supports the formation of azo-like linkages under certain conditions.

As various changes could be made in the above constructions without departing from the scope of the invention, it is intended that all matter contained in the above description or shown in the accompanying drawings shall be interpreted as illustrative and not in a limiting sense.

What is claimed is:

1. An ion-selective electrode (ISE) comprising:
a working electrode;
a transduction layer disposed on the working electrode; and,
an ion-selective membrane (ISM) disposed on the transduction layer, the ISM having a thickness less than 100 μm.

2. The ion-selective electrode system of claim 1 wherein the transduction layer is a redox-active conducting polymer.

3. The ion-selective electrode system of claim 2 wherein the transduction layer comprises a material selected from the list comprising polypyrrole, polyaniline, poly(3,4-ethylenedioxythiophene) (PEDOT), polythiophene, poly(3-hexylthiophene), polyindole, polycarbazole, polyfuran, poly(phenylenevinylene), poly(p-phenylene), polyacetylene.

4. The ion-selective electrode system of claim 1 wherein the ion-selective membrane is formed by a process of molecular-layer deposition.

5. The ion-selective electrode system of claim 1 wherein the thickness of the ion-selective membrane is less than 100 nm.

6. The ion-selective electrode system of claim 1 wherein the ion-selective membrane is exclusive of ionophores.

7. The ion-selective electrode system of claim 1 wherein the ion-selective membrane is formed by a process that excludes ion templating.

8. The ion-selective electrode system of claim 1 wherein the ion-selective membrane is exclusive of dopants.

9. The ion-selective electrode system of claim 1 wherein the ion-selective membrane comprises a homopolymer or copolymer of at least one of polypyrrole, polyaniline, poly(3,4-ethylenedioxythiophene), polythiophene, poly(p-phenylenediamine), polythiourea, polyethyleneimine, poly(allylamine), ethyl cellulose, poly(methyl methacrylate), poly(vinylidene fluoride-co-hexafluoropropylene) (PVDF-HFP), poly(vinyl alcohol), poly(2-hydroxyethyl methacrylate), polyacrylamide, perfluorosulfonic acid ionomer, sulfonated polystyrene (PSS) ionomer, and PTFE.

10. A method of selectively measuring a concentration of an anion in a liquid sample, the method comprising:
a sample exposure step of exposing an ion-selective electrode (ISE) to the liquid sample, the ion-selective electrode comprising:
a working electrode;
a transduction layer disposed on the working electrode; and,
an ion-selective membrane (ISM) disposed on the transduction layer, the ISM having a thickness that is less than 100 μm,
such that a sample-ISM interface forms between the liquid sample and the ISM;
an equilibration step in which an equilibrium phase boundary potential is formed at the sample-ISM interface;
a charging step of applying an electrical current pulse to reversibly oxidize the transduction layer, during which charged phase boundary potential at the sample-ISM interface is measured and recorded;
a phase boundary change calculation step comprising subtracting the equilibrium phase boundary potential from the charged phase boundary potential to calculate a phase boundary potential change Δφ; and
a concentration calculation step of calculating the concentration of the anion in the liquid sample from the phase boundary potential change Δφ.

11. The method of claim 10 further comprising a regeneration step after charging step.

12. The method of claim 10 wherein the thickness of the ion-selective membrane is less than 100 nm.

13. The method of claim 10 wherein the ion-selective membrane is exclusive of ionophores.

14. The method of claim 10 wherein the ion-selective membrane is formed by a process that excludes ion templating.

15. A system for selectively measuring the concentration of an anion in a liquid solution, the system comprising:
an ion-selective electrode comprising:
a working electrode;
a transduction layer disposed on the working electrode; and,
an ion-selective membrane (ISM) disposed on the transduction layer, the ISM having a thickness less than 100 μm;
an analytical instrument operably connected to the ion-selective electrode;
a reference electrode operably connected to the analytical instrument; and
a counter electrode operably connected to the analytical instrument.

16. The system of claim 15 wherein the thickness of the ion-selective membrane is less than 100 nm.

17. The system of claim 15 wherein the ion-selective membrane is exclusive of ionophores.

18. The system of claim 15 wherein the reference electrode is a polarizable reference electrode.

19. The system of claim 15 wherein the ion-selective membrane is formed by a process of molecular-layer deposition.

20. The system of claim 15 further comprising at least one additional ion-selective electrode, wherein the liquid solution comprises a plurality of different anion species.
